(19) United States
(12) Patent Application Publication
(10) Pub. No.: US 2026/0046450 A1
(43) Pub. Date: Feb. 12, 2026

(54) ENCODING AND DECODING METHOD, CODE STREAM, ENCODER, DECODER AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/359,496

(22) Filed: Oct. 15, 2025

Related U.S. Application Data
(63) Continuation of application No. PCT/CN2023/088808, filed on Apr. 17, 2023.

(51) Int. Cl. H04N 19/597; H04N 19/124; H04N 19/136; H04N 19/184; H04N 19/30

(52) U.S. Cl. CPC H04N 19/597; H04N 19/124; H04N 19/136; H04N 19/184; H04N 19/30

(57) ABSTRACT

An encoding, a decoding method, and a storage medium are provided. The method includes: determining the number of parent node neighborhood nodes of a current node; when the number of parent node neighborhood nodes of the current node is greater than or equal to a preset threshold value, determining that the current node allows attribute prediction; and determining a predicted attribute value of a child node of the current node on the basis of attribute information of the neighborhood nodes of the current node.

### CROSS-REFERENCE TO RELATED APPLICATION

This application is a continuation of International Patent Application No. PCT/CN2023/088808 filed on Apr. 17, 2023, the entire content of which is hereby incorporated by reference in its entirety.

### BACKGROUND

In the Geometry-based Point Cloud Compression (G-PCC) encoding and decoding framework, the geometric information and attribute information of the point cloud are coded separately. The attribute coding of G-PCC may include the Predicting Transform (PT), the Lifting Transform (LT), and the Region Adaptive Hierarchical Transform (RAHT).

In the above RAHT attribute coding, when prediction coding is performed on the attribute transform coefficient of each node, there are start-up conditions for whether to start prediction coding. However, due to inadequate consideration in the related art, the prediction coding of the attribute transform coefficient of the current node is only performed when all the start-up conditions are met, which leads to low attribute coding efficiency of the point cloud.

### SUMMARY

Embodiments of the present disclosure provide an encoding, a decoding method, and a storage medium.

The technical solutions of the embodiments of the present disclosure may be realized as follows.

In a first aspect, the embodiments of the present disclosure provide a decoding method. The method is applied to a decoder and includes the following operations.

A number of neighbouring nodes of a parent node of a current node is determined.

When the number of the neighbouring nodes of the parent node of the current node is greater than or equal to a preset threshold, it is determined that attribute prediction is allowed for the current node.

An attribute prediction value of a child node of the current node is determined based on attribute information of neighbouring nodes of the current node.

In a second aspect, the embodiments of the present disclosure provide an encoding method. The method is applied to an encoder and includes the following operations.

A number of neighbouring nodes of a parent node of a current node is determined.

When the number of the neighbouring nodes of the parent node of the current node is greater than or equal to a preset threshold, it is determined that attribute prediction is allowed for the current node.

An attribute prediction value of a child node of the current node is determined based on attribute information of neighbouring nodes of the current node.

In a third aspect, an embodiment of the present disclosure provides a non-transitory computer-readable storage medium, having a computer program and a bitstream stored thereon. The computer program, when executed by a processor, enables the processor to perform operations of the encoding method in the second aspect to generate the bitstream.

### BRIEF DESCRIPTION OF THE DRAWINGS

FIG. 1A is a schematic diagram of a three-dimensional (3D) point cloud image.

FIG. 1B is a partial enlarged view of a three-dimensional point cloud image.

FIG. 2A is a schematic view of six viewing angles of a point cloud image.

FIG. 2B is a schematic diagram of a data storage format corresponding to a point cloud image.

FIG. 3 is a schematic diagram of a network architecture of point cloud encoding and decoding.

FIG. 4A is a schematic diagram of a component framework of a G-PCC encoder.

FIG. 4B is a schematic diagram of a component framework of a G-PCC decoder.

FIG. 5A is a schematic diagram of a position of a bottom virtual plane in a Z-axis direction.

FIG. 5B is a schematic diagram of a position of a top virtual plane in a Z-axis direction.

FIG. 6 is a schematic diagram of a sequence of node encoding.

FIG. 7A is a schematic diagram of planar mode information.

FIG. 7B is another schematic diagram of planar mode information.

FIG. 8 is a schematic diagram of sibling nodes of a current node.

FIG. 9 is a schematic diagram of the intersections of lidars and a node.

FIG. 10 is a schematic diagram of neighbouring nodes at the same partitioning depth and the same coordinates.

FIG. 11 is schematic diagrams of current nodes located at positions of the bottom virtual plane of parent nodes.

FIG. 12 is schematic diagrams of current nodes located at positions of the top virtual plane of parent nodes.

FIG. 13 is a schematic diagram of prediction coding of plane position information of a lidar point cloud.

FIG. 14 is a schematic diagram of an Infer Direct Coding Model (IDCM) coding.

FIG. 15 is a schematic diagram of coordinate transform of a point cloud obtained by a rotating lidar.

FIG. 16 is a schematic diagram of prediction coding in an X-axis direction or a Y-axis direction.

FIG. 17A is a schematic diagram of a Y-plane angle prediction through horizontal azimuth.

FIG. 17B is a schematic diagram of an X-plane angle prediction through horizontal azimuth.

FIG. 18 is another schematic diagram of prediction coding in an X-axis direction or a Y-axis direction.

FIG. 19A is a schematic diagram of three intersection points included in a sub-block.

FIG. 19B is a schematic diagram of a triangle soup (trisoup) fitted by using three intersection points.

FIG. 19C is an upsampling diagram of a trisoup.

FIG. 20 is a schematic diagram of a distance-based Level of Detail (LOD) construction process.

FIG. 21 is a schematic diagram of a visualization result of a LOD generation process.

FIG. 22 is a schematic diagram of an encoding flow of attribute prediction.

FIG. 23 is a schematic diagram of a composition of a pyramid structure.

FIG. 24 is another schematic diagram of a composition of a pyramid structure.

FIG. 25 is a schematic diagram of an LOD structure for inter-layer nearest neighbouring search.

FIG. 26 is a schematic diagram of a nearest neighbouring search structure based on a spatial relationship.

FIG. 27A is a schematic diagram of a coplanar spatial relationship.

FIG. 27B is a schematic diagram of a coplanar and collinear spatial relationship.

FIG. 27C is a schematic diagram of a coplanar, collinear and concurrent spatial relationship.

FIG. 28 is a schematic diagram of an inter-layer prediction based on fast search.

FIG. 29 is a schematic diagram of an LOD structure of intra-layer nearest neighbouring search of attributes.

FIG. 30 is a schematic diagram of intra-layer prediction based on fast search.

FIG. 31 is a schematic diagram of a block-based neighbouring search structure.

FIG. 32 is a schematic diagram of an encoding flow of a lifting transform.

FIG. 33 is a schematic diagram of a RAHT transform structure.

FIG. 34 is a schematic diagram of a transform process of a RAHT along x, y and z directions.

FIG. 35A is a schematic diagram of a process of a RAHT forward transform.

FIG. 35B is a schematic diagram of a process of a RAHT inverse transform.

FIG. 36 is a schematic structural diagram of an attribute coding block.

FIG. 37 is an overall flow diagram of a RAHT attribute prediction transform coding.

FIG. 38 is a schematic diagram of a neighbouring prediction relationship of a current block.

FIG. 39 is a schematic diagram of a calculation process of an attribute transform coefficient.

FIG. 40 is a schematic structural diagram of a RAHT attribute inter-prediction coding.

FIG. 41 is a first schematic flowchart of a decoding method according to an embodiment of the present disclosure.

FIG. 42 is a second schematic flowchart of a decoding method according to an embodiment of the present disclosure.

FIG. 43 is a schematic flowchart of an encoding method according to an embodiment of the present disclosure.

FIG. 44 is a schematic diagram of a structural composition of an encoder according to an embodiment of the present disclosure.

FIG. 45 is a schematic diagram of a specific hardware structure of an encoder according to an embodiment of the present disclosure.

FIG. 46 is a schematic diagram of a structural composition of a decoder according to an embodiment of the present disclosure.

FIG. 47 is a schematic diagram of a specific hardware structure of a decoder according to an embodiment of the present disclosure.

FIG. 48 is a schematic diagram of a structural composition of an encoding and decoding system according to an embodiment of the present disclosure.

### DETAILED DESCRIPTION

In order to enable a more detailed understanding of the features and technical contents of the embodiments of the present disclosure, implementations of the embodiments of the present disclosure will be described in detail below in conjunction with the accompanying drawings. The accompanying drawings are provided solely for purposes of reference and illustration and are not intended to limit the embodiments of the present disclosure.

Unless otherwise defined, all technical and scientific terms used herein have the same meaning as commonly understood by those skilled in the technical field of the present disclosure. The terms used herein are only for the purpose of describing the embodiments of the present disclosure, and is not intended to limit the present disclosure.

In the following description, reference is made to “some embodiments”, which describe a subset of all possible embodiments. However, it can be understood that “some embodiments” may refer to the same subset or different subsets of all possible embodiments, and may be combined with each other without conflict.

It should be noted that the terms “first\second\third” involved in embodiments of the present disclosure are only used to distinguish similar objects and do not represent a specific order. It can be understood that such used “first\second\third” may be interchanged in specific order or sequence where permitted, so that the embodiments of the present disclosure described herein may be implemented in an order other than those illustrated or described herein.

A point cloud is a three-dimensional representation of a surface of an object. The point cloud (data) on the surface of the object may be collected through photoelectric radar, lidar, laser scanner, multi-view camera and other acquisition devices.

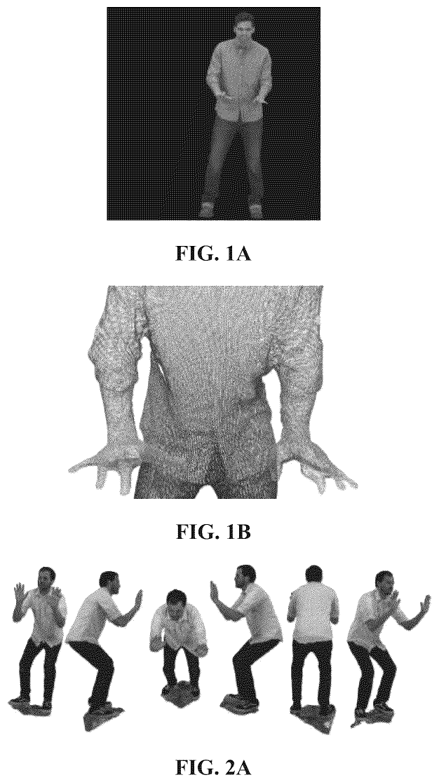

The point cloud is a set of irregularly distributed discrete points in space that express the spatial structure and surface attribute of three-dimensional objects or scenes. FIG. 1A illustrates a three-dimensional point cloud image and FIG. 1B illustrates a partial enlarged view of the three-dimensional point cloud image. It can be seen that the surface of the point cloud is composed of densely distributed points.

The two-dimensional image contains information expression at each pixel and has a regular distribution. Therefore, there is no need to record its position information additionally. However, the distribution of points in the point cloud in the three-dimensional space is random and irregular. Therefore, it is necessary to record the respective position of each point in the space, so as to completely express the point cloud. Similar to two-dimensional images, there exists corresponding attribute information at each position in the acquisition process, which is usually an RGB colour value. The colour value reflects the colour of the object. For a point cloud, in addition to colour information, a common type of the attribute information corresponding to each point is the reflectance value, which reflects the surface material of the object. Therefore, the point cloud data usually includes position information of the point and attribute information of the point. The position information of the point may also be referred to as the geometric information of the point. For example, the geometric information of the point may be three-dimensional coordinate information (x, y, z) of the point. The attribute information of the point may include colour information and/or reflectance, and the like. For example, the reflectance may be one-dimensional reflectance information (r). The colour information may be information in any colour space, or the colour information may be three-dimensional colour information, such as RGB information. Here, R denotes Red (R), G denotes Green (G), and B denotes Blue (B). As another example, the colour information may be luma chroma (YCbCr, YUV) information. Here, Y represents brightness (Luma), Cb (U) represents blue colour aberration, and Cr (V) represents red colour aberration.

The points in the point cloud obtained according to the principle of laser measurement may include the three-dimensional coordinate information of the points and the reflectance values of the points. For another example, the points in the point cloud obtained according to the principle of photogrammetry may include the three-dimensional coordinate information of the points and the three-dimensional colour information of the points. For another example, the points in the point cloud obtained by combining the principles of laser measurement and photogrammetry may include the three-dimensional coordinate information of the points, the reflectance values of the points, and the three-dimensional colour information of the points.

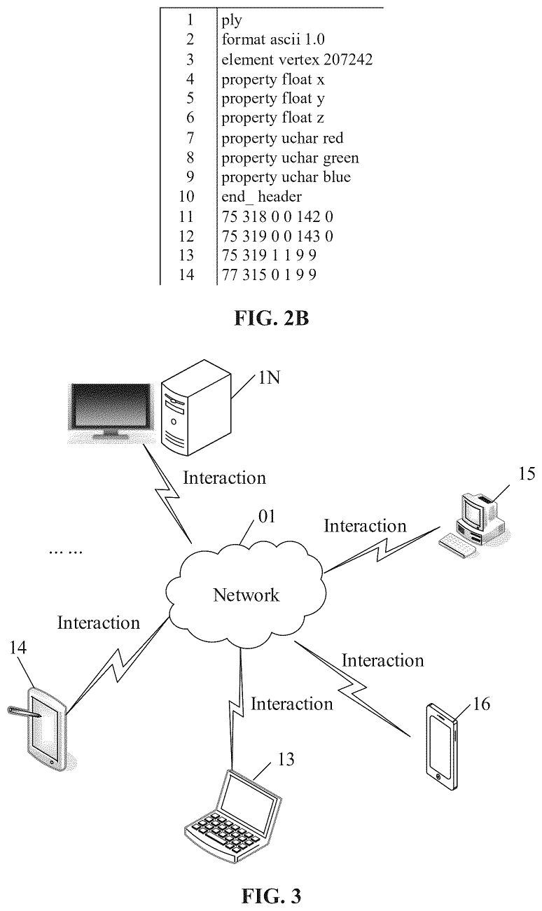

FIGS. 2A and 2B illustrate a point cloud image and data storage format corresponding to the point cloud image. FIG. 2A provides six viewing angles of the point cloud image, and FIG. 2B is composed of a file header information part and a data part. The header information includes a data format, a data representation type, a total number of the points in the point cloud, and a content represented by the point cloud. For example, the point cloud is in the format of “.ply” and represented by ASCII code, with a total number of points of 207242. Each point has three-dimensional coordinate information (x, y, z) and three-dimensional colour information (r, g, b).

The point clouds may be classified, based on the acquisition methods, into a static point cloud, a dynamic point cloud, and a dynamically acquired point cloud.

For the static point cloud, the object is stationary, and the device that acquires the point cloud is also stationary.

For the dynamic point cloud, the object is in motion, but the device that acquires the point cloud is stationary.

For the dynamically acquired point cloud, the device that acquires the point cloud is in motion.

For example, the point cloud is classified into the following two categories based on the application purposes.

First category: a Machine-perceived point cloud, which may be used in scenarios such as autonomous navigation systems, real-time inspection systems, geographic information systems, visual sorting robots, emergency rescue and disaster relief robots.

Second category: human eye-perceived point cloud, which may be used in point cloud application scenarios such as digital cultural heritage, free viewpoint broadcasting, three-dimensional immersive communication, and three-dimensional immersive interaction.

The point cloud may flexibly and conveniently express the spatial structure and surface attribute of three-dimensional objects or scenes. Because the point cloud is obtained by directly sampling real objects, it can provide a strong sense of realism on the premise of ensuring accuracy and is widely used. The application scenario includes the virtual reality games, the computer-aided design, the geographic information systems, the automatic navigation systems, the digital cultural heritage, the free viewpoint broadcasting, the three-dimensional immersive telepresentation, the three-dimensional reconstruction of biological tissues and organs, etc.

The acquisition of the point cloud mainly includes the following manners: computer generation, 3D laser scanning, 3D photogrammetry, etc. The computers may generate the point clouds of virtual three-dimensional objects and scenes. The 3D laser scanning may obtain the point clouds of static real-world three-dimensional objects or scenes, and millions of point clouds may be obtained per second. The 3D photogrammetry may obtain the point clouds of dynamic real-world three-dimensional objects or scenes, and tens of millions of point clouds may be obtained per second. These technologies reduce the cost and time period of the acquisition of the point cloud data, and improve the accuracy of data. The change of acquisition method of the point cloud data makes it possible to acquire a large amount of point cloud data. With the growth of application demand, the processing of massive 3D point cloud data encounters the bottleneck imposed by the storage space and the transmission bandwidth.

Exemplarily, taking a point cloud video with a frame rate of 30 frames per second (fps) as an example, the number of points in each frame of the point cloud is 700,000, and each point has the coordinate information xyz (float) and the colour information RGB (uchar), then the data amount of the 10 s point cloud video is about 0.7 millionx(4 Bytex3+1 Byte×3)×30 fps×10 s=3.15 GB. Here, 1 Byte is 10 bits. For a two-dimensional video with a YUV sampling format of 4:2:0, a frame rate of 24 fps and a resolution of 1280×720, the data amount for 10 s is about 1280×720×12 bit×24 fps×10 s≈0.33 GB, and the data amount for 10 s two-view three-dimensional video is about 0.33×2=0.66 GB. It can be seen that the data amount of the point cloud video far exceeds the data amount of the two-dimensional video and three-dimensional video of the same duration. Therefore, in order to better realize the data management, save the storage space for the server, and reduce the transmission traffic and transmission time between the server and the client, the point cloud compression has become a key issue in prompting the development of the point cloud industry.

In other words, because the point cloud is a collection of massive points, storing the point cloud will not only consume a large amount of memory, but also be not conducive to transmission. In addition, there is no such large bandwidth to support the direct transmission of the point cloud at the network layer without compression. Therefore, the point cloud needs to be compressed.

At present, the point cloud coding framework that may compress the point cloud may be a Geometry-based Point Cloud Compression (G-PCC) coding framework or a Video-based Point Cloud Compression (V-PCC) coding framework provided by the Moving Picture Experts Group (MPEG), or may be the Audio Video Coding Standard-Point Cloud Compression (AVS-PCC) coding framework provided by the Audio Video coding Standard (AVS). The G-PCC coding framework may be used to compress the first type of static point cloud and the third type of the dynamically acquired point cloud, which may be based on the point cloud compression test platform (Test Model Compression 13, TMC13). The V-PCC coding framework may be used to compress the second type of dynamic point cloud, which may be based on the point cloud compression test platform (Test Model Compression 2, TMC2). Therefore, the G-PCC coding framework is also referred to as the point cloud codec TMC13, and the V-PCC coding framework is also referred to as the point cloud codec TMC2.

The embodiments of the present disclosure provide a network architecture of a point cloud encoding and decoding system including a decoding method and an encoding method. FIG. 3 illustrates a schematic diagram of a network architecture of the point cloud encoding and decoding system according to the embodiment of the present disclosure. As illustrated in FIG. 3, the network architecture includes one or more electronic devices (i.e., electronic device 13 to electronic device 1N) and a communication network 01. The electronic device 13 to electronic device 1N may conduct video interaction through the communication network 01. The electronic device may be various types of devices having point cloud encoding and decoding functions in the process of implementation. For example, the electronic device may include a mobile phone, a tablet computer, a personal computer, a personal digital assistant, a navigator, a digital telephone, a video telephone, a television, a sensing device, a server, and the like, which is not limited in the embodiments of the present disclosure. The decoder or encoder in the embodiments of the present disclosure may be the electronic device described above.

The electronic device in the embodiments of the present disclosure has the point cloud encoding and decoding function, and generally includes a point cloud encoder (i.e., an encoder) and a point cloud decoder (i.e., a decoder).

The following describes the related technology by taking the G-PCC coding framework as an example.

It may be understood that in the point cloud G-PCC encoding and decoding framework, the point cloud data to be encoded is first partitioned into multiple slices by slice partitioning. In each slice, the geometric information of the point cloud and the attribute information corresponding to each point are encoded separately.

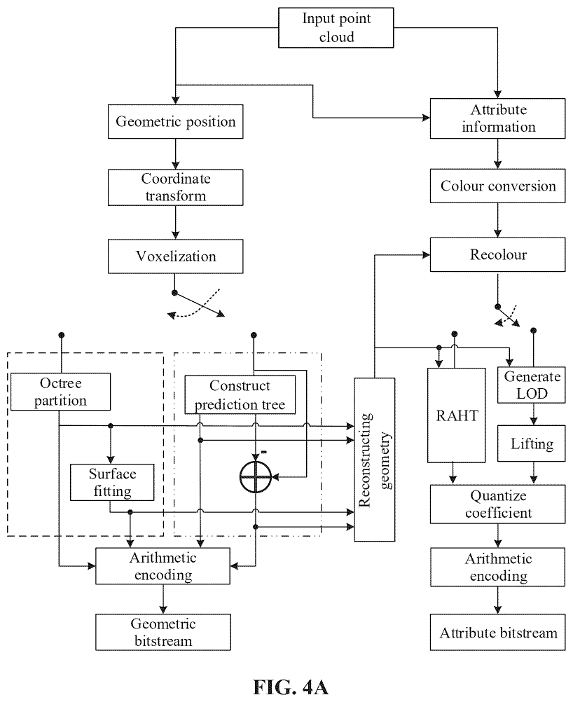

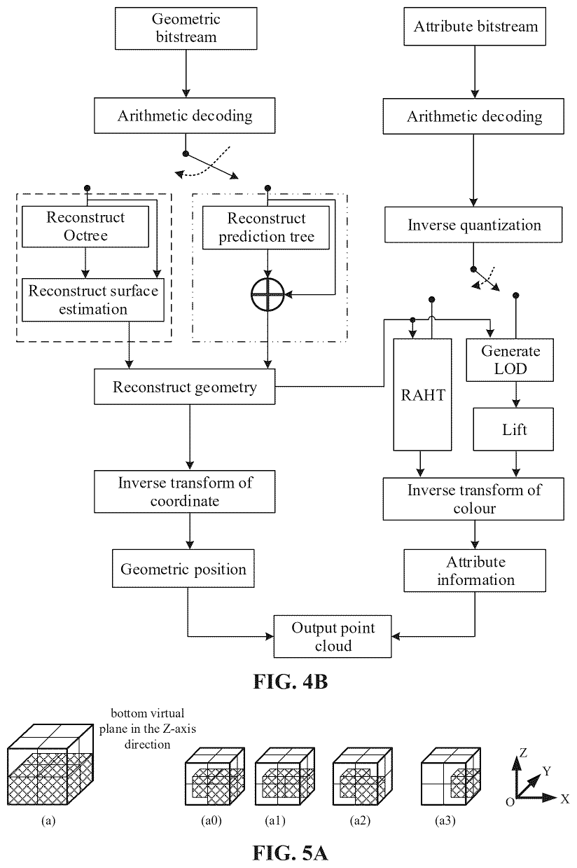

FIG. 4A illustrates a schematic diagram of a component framework of a G-PCC encoder. As illustrated in FIG. 4A, in the geometry encoding process, the coordinate transform is performed on the geometric information, so that all the point clouds are contained in a Bounding Box and then quantized. This operation of quantization mainly plays the role of scaling. Due to quantization and rounding, the geometric information of some point clouds is the same, and whether to remove duplicate points is decided based on the parameters. The process of quantizing and removing duplicate points is also referred to as the voxelization process. Then the octree partitioning or the construction of a prediction tree is performed on the bounding box. In this process, the points in the partitioned leaf nodes are arithmetically encoded to generate a binary geometric bitstream. Alternatively, the intersection points (Vertex) generated by the partition are arithmetically encoded (surface fitting is performed based on the intersection point) to generate a binary geometric bitstream. In the process of attribute encoding, after the geometry encoding is completed and the geometric information is reconstructed, it is necessary to perform colour conversion first to convert the colour information (i.e. attribute information) from the RGB colour space to the YUV colour space. Then, the point cloud is recoloured by using the reconstructed geometric information so that the unencoded attribute information corresponds to the reconstructed geometric information. The attribute encoding is mainly performed for the colour information. In the process of encoding the coulor information, there are mainly two transform methods. One is the distance-based lifting transform that relies on the Level of Detail (LOD) partitioning, and the other one is the direct Region Adaptive Hierarchal Transform (RAHT). These two methods will convert the colour information from the spatial domain to the frequency domain, obtain the high-frequency coefficients and the low-frequency coefficients through transform. Finally, the coefficients are quantized, and then arithmetically encoding is performed on the quantized coefficients to generate binary attribute bitstreams.

FIG. 4B illustrates a schematic diagram of a component framework of a G-PCC decoder. As illustrated in FIG. 4B, firstly, for the acquired binary bitstream, the geometric bitstream and the attribute bitstream in the binary bitstream are decoded independently and respectively. When decoding the geometric bitstream, the geometric information of the point cloud is obtained by arithmetic decoding-reconstructing octree/reconstructing prediction tree-reconstructing geometry-inverse transform of coordinates. When decoding the attribute bitstream, the attribute information of the point cloud is obtained by arithmetic decoding-inverse quantization-LOD partition/RAHT-inverse transform of colour, and the point cloud data to be encoded is restored based on the geometric information and the attribute information (i.e. output the point cloud).

It should be noted that, as illustrated in FIG. 4A or FIG. 4B, the current geometry coding and decoding of the G-PCC may be divided into the Octree geometry coding and decoding (identified by a dashed line frame) and the prediction tree-based geometry coding and decoding (identified by a dotted line frame).

The Octree geometry encoding (OctGeomEnc) includes the following operations. Firstly, coordinate transform is performed on the geometric information so that all point clouds are contained in a bounding box, and then quantization is performed. The operation of quantization mainly plays the role of scaling. Because of the quantization and rounding, the geometric information of some points is the same. Whether to remove duplicate points is decided based on the parameters. The process of quantizing and removing duplicate points is also referred to as Voxelization process. Next, the tree partitioning (such as octree, quadtree, binary tree, etc.) is continuously performed on the bounding box in the order of breadth-first traversal, and the occupancy code of each node is encoded. In the related art, a company proposed an implicit geometry partition method. Firstly, the bounding box (2^{d}^{ₓ}, 2^{d}^{_{y}}, 2^{d}^{_{z}}) of the point cloud is calculated. It is assumed that dₓ>d_{y}>d_{z} and the bounding box corresponds to a cuboid. When performing the geometric partitioning, firstly, the binary tree partitioning is continuously performed based on the x-axis to obtain two child nodes. When the condition dₓ=d_{y}>d_{z} is met, the quad tree partitioning is continuously performed based on the x and y axes to obtain four child nodes. Finally, when the condition dₓ=d_{y}=d_{z} is met, the octree partitioning is continuously performed until the leaf nodes obtained through partitioning are unit cubes of 1×1×1, at which point the partitioning stops. The points in the leaf nodes are encoded to generate a binary bitstream. In the process of binary tree/quadtree/octree partitioning, two parameters (i.e., K and M) are introduced. The parameter K indicates the maximum number of the binary tree partitioning/quadtree partitioning before the octree partitioning is performed. The parameter M is configured to indicate that the corresponding minimum block side length is 2^{M} when performing the binary tree partitioning/quadtree partitioning. K and M must meet the following conditions: assuming that dₘₐₓ=max(dₓ, d_{y}, d_{z}) and dₘᵢₙ=min(dₓ, d_{y}, d_{z}), the parameter K meets the condition that K≥dₘₐₓ−dₘᵢₙ and the parameter M meets the condition that M≥dₘᵢₙ. The reason why the parameters K and M meet the above conditions is that in the process of the geometric implicit partitioning of the G-PCC at present, the priority of the partitioning methods is binary tree, quadtree and octree. When the node block size does not meet the condition of binary tree/quadtree, the octree partitioning is continuously performed on the node until the smallest unit 1×1×1 of leaf nodes are obtained through the partition. The OctGeomEnc mode can effectively encode the geometric information of point cloud by using the correlation between neighbouring points in space. However, for some flat nodes or nodes with planar characteristics, the efficiency of the encoding of the geometric information of the point cloud can be further improved by using the planar encoding.

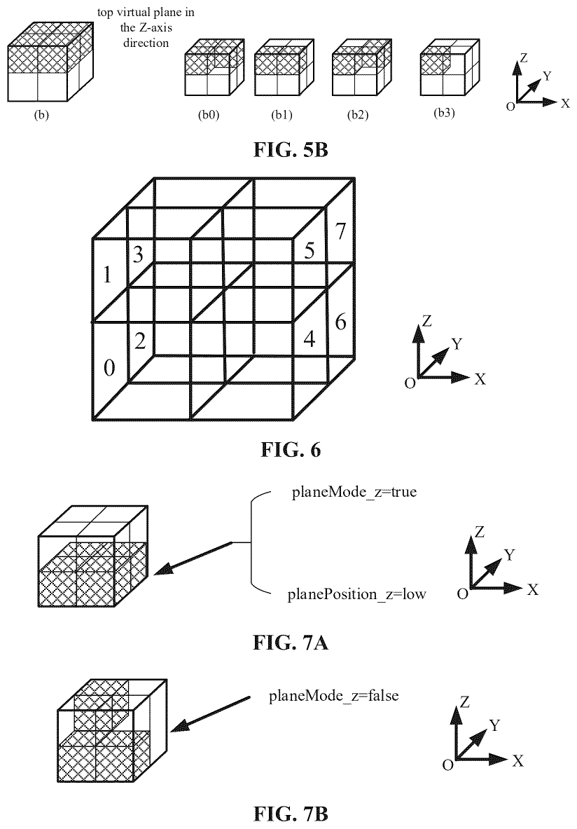

Exemplarily, FIG. 5A and FIG. 5B provide schematic diagrams of a position of a plane. FIG. 5A illustrates a schematic diagram of a position of the bottom virtual plane in the Z-axis direction, and FIG. 5B illustrates a schematic diagram of a position of the top virtual plane in the Z-axis direction. As illustrated in FIG. 5A, (a), (a0), (a1), (a2), and (a3) here all belong to the positions of the bottom virtual plane in the Z-axis direction. Taking (a) as an example, it can be seen that the occupied four child nodes in the current node are all located at the position of the bottom virtual plane of the current node in the Z-axis direction, so it may be considered that the current node belongs to a Z-plane and is a bottom virtual plane in the Z-axis direction. Similarly, as illustrated in FIG. 5B, (b), (b0), (b1), (b2), and (b3) here all belong to the positions of the top virtual plane in the Z-axis direction. Taking (b) as an example, it may be seen that the four occupied child nodes in the current node are located at the position of the top virtual plane of the current node in the Z-axis direction, so it may be considered that the current node belongs to a Z-plane and is a top virtual plane in the Z-axis direction.

Further, taking (a) in FIG. 5A as an example, the efficiency of the octree encoding is compared with the efficiency of the planar encoding. FIG. 6 provides a schematic diagram of a sequence of node encoding, that is, node coding is performed in the sequence of 0, 1, 2, 3, 4, 5, 6, and 7 illustrated in FIG. 6. Here, if the octree encoding method is adopted for (a) in FIG. 5A, the occupancy information of the current node is represented as: 11001100. However, if the planar encoding method is adopted, firstly, an identifier needs to be encoded to indicate that the current node is a plane in the Z-axis direction, and secondly, if the current node is a plane in the Z-axis direction, the position of the plane of the current node needs to be represented. Secondly, only the occupancy information of the bottom virtual plane node (that is, the occupancy information of the four child nodes 0, 2, 4, and 6) in the Z-axis direction needs to be encoded. Therefore, only 6 bits need to be encoded to encode the current node based on the planar encoding method, which can reduce the representation by 2 bits compared with the octree encoding of related technologies. Based on this analysis, planar encoding has significant encoding efficiency compared with the octree encoding. Therefore, for an occupied node, if the planar encoding is used for encoding in a certain dimension, firstly, the planar mode (i.e., planarMode) information and the plane position (PlanePos) information of the current node in this dimension need to be represented, and secondly, the occupancy information of the current node needs to be encoded based on the plane information of the current node. Exemplarily, FIG. 7A illustrates a schematic diagram of planar mode information. As illustrated in FIG. 7A, the current node is a bottom virtual plane in the Z-axis direction. Correspondingly, the value of the plane mode information is true or 1, that is, planarMode__{Z}=true. The plane position information is bottom virtual plane (low), that is, PlanePosition__{Z}=low. FIG. 7B illustrates another schematic diagram of the planar mode information. As illustrated in FIG. 7B, the current node is not one plane in the Z-axis direction. Correspondingly, the value of the plane mode information is false or 0, that is, planarMode__{Z}=false.

It should be noted that for PlaneMode_ᵢ: 0 denotes that the current node is not a plane in the i-axis direction, and 1 denotes that the current node is a plane in the i-axis direction. If the current node is a plane in the i-axis direction, for PlanePosition_ᵢ: 0 denotes that the current node is a plane in the i-axis direction and the plane position is a bottom virtual plane, and 1 denotes that the current node is a top virtual plane in the i-axis direction. Here, i denotes a coordinate dimension, which may be the X-axis direction, the Y-axis direction, or the Z-axis direction, so i=0, 1, 2.

In the G-PCC standard, when judging whether a node meets the planar encoding condition and when the node meets the planar encoding condition, it is necessary to perform prediction encoding for the plane mode information and plane position information of the node.

In the embodiments of the present disclosure, there are three kinds of judgment conditions for judging whether a node meets the judgment condition of the planar encoding in the current G-PCC standard, which are described in detail one by one below.

### 1. Judgment According to the Plane Probability of the Node in Each Dimension.

(1) Determine the local area density (local_node_density) of the current node.

(2) Determine the probability Prob (i) of the current node in each dimension.

When the local area density of the node is less than the threshold Th (e.g., Th=3), the plane probabilities Prob (i) of the current node in three coordinate dimensions are compared with the thresholds Th0, Th1, and Th2. Here, Th0<Th1<Th2 (e.g., Th0=0.6, Th1=0.77, Th2=0.88). Eligibleᵢ (i=0, 1, 2) may be used to represent whether planar encoding is started in each dimension: Eligibleᵢ=Prob (i)>=threshold.

It should be noted that the threshold is adaptively changed, for example, when Prob (0)>Prob (1)>Prob (2), Eligibleᵢ is set as follows:

$${Eligible}_{0} = Prob ( 0 ) >= Th 0 ;$$

$${Eligible}_{1} = Prob ( 1 ) >= Th 1 ;$$

$${Eligible}_{2} = Prob ( 2 ) >= Th 2.$$

When Prob (1)>Prob (0)>Prob (2), Eligibleᵢ is set as follows:

$${Eligible}_{0} = Prob ( 0 ) >= Th 1 ;$$

$${Eligible}_{1} = Prob ( 1 ) >= Th 0 ;$$

$${Eligible}_{2} = Prob ( 2 ) >= Th 2.$$

Here, the update of Prob (i) is as follows:

$${Prod ( i )}_{new} = ( L \times Prob ( i ) + δ ( coded node ) ) / L + 1 \qquad ( 1 )$$

Here, L=255. In addition, if the coded node is a plane, δ (coded node) is 1. Otherwise δ (coded node) is 0.

Here, the update of local_node_density is as follows:

$$Local\_node {\_density}_{new} = local\_node \_density + 4 * numSiblings \qquad ( 2 )$$

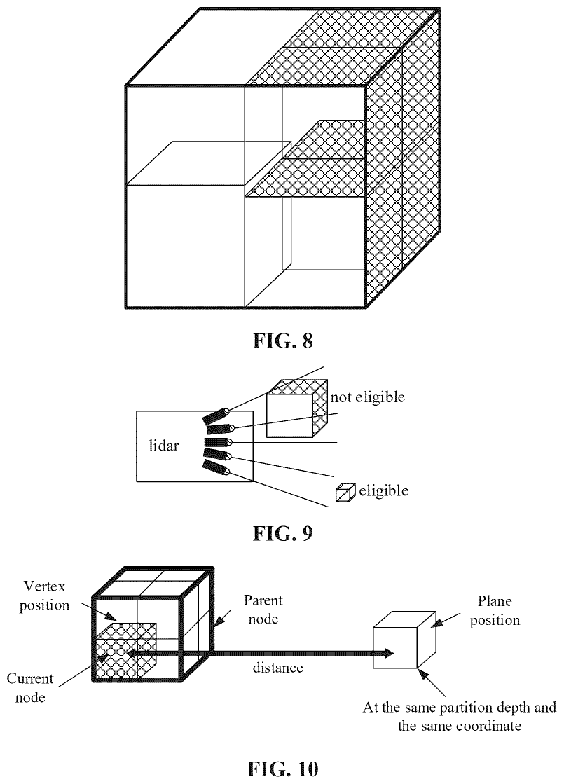

Here, local_node_density is initialized to be 4, and numSiblings is the number of sibling nodes of this node. Exemplarily, FIG. 8 illustrates a schematic diagram of sibling nodes of a current node. As illustrated in FIG. 8, the current node is a node filled with slashes and the node filled with grids is a sibling node, so the number of sibling nodes of the current node is 5 (including the current node itself).

### 2. Determination of Whether the Nodes of the Current Layer Meet the Planar Encoding According to the Point Cloud Density of the Current Layer

The density of the points of the current layer is used to determine whether to perform planar encoding on the nodes of the current layer. Assuming that the number of points in the current point cloud to be encoded is pointCount, the number of points that have been reconstructed by the Infer Direct Coding Model (IDCM) encoding is numPointCountRecon. Because the octree is encoded based on the order of breadth-first traversal, the number of nodes to be encoded in the current layer may be assumed as nodeCount, and then whether planar encoding is started for the current layer is assumed to be planarEligibleKOctreeDepth, specifically: planarEligibleK OctreeDepth=(pointCount-numPointCountRecon)<nodeCount×1.3.

Here, if (pointCount-numPointCountRecon) is less than nodeCount×1.3, planarEligibleK OctreeDepth is true. If (pointCount-numPointCountRecon) is not less than nodeCount×1.3, planarEligibleKOctreeDepth is false. In this way, when planarEligibleKOctreeDepth is true, the planar encoding is performed on all nodes in the current layer. Otherwise, the planar encoding is not performed for all nodes in the current layer, and only the octree encoding is used.

### 3. Determination of Whether the Current Node Meets the Planar Encoding According to the Acquisition Parameters of the Lidar Point Cloud

FIG. 9 illustrates a schematic diagram of an intersection of lidars with a node. As illustrated in FIG. 9, the node filled with grids is traversed by two Laser rays (Laser) at the same time, so the current node is not a plane in the vertical direction of the Z-axis. The node filled with slashes is too small to be crossed by two Lasers at the same time. Therefore, it is possible that the node filled with the slashes is a plane in the Z-axis vertical direction.

Further, the prediction encoding may be performed on the plane mode information and the plane position information for a node meeting the planar encoding condition.

Firstly, the prediction encoding is performed on the plane mode information.

Here, only three pieces of context information are used for encoding, that is, the context for the plane mode on each coordinate dimension is designed separately.

Secondly, the prediction encoding is performed on the plane position information.

It should be understood that, for the encoding of non-Lidar point cloud plane position information, the prediction encoding of the plane position information may include the following operations:

(a) Prediction is performed by using the occupancy information of the neighbouring nodes to obtain the plane position information of the current node. The plane position information of the current node includes the following three elements: predicted as bottom virtual plane, predicted as top virtual plane and cannot be predicted.

(b) The spatial distance between the node (which is at the same partitioning depth and at the same coordinates as the current node) and the current node is divided into two types: “close” and “far”.

(c) If the node at the same partition depth and at the same coordinates as the current node is a plane, the plane position of the node is determined.

(d) Coordinate dimensions (i=0, 1, 2).

It should be noted that, in the embodiments of the present disclosure, after the spatial distance between the node at the same partitioning depth and at the same coordinates as the current node and the current node is determined, if the spatial distance is less than a preset distance threshold, it may be determined that the spatial distance is “close”. Alternatively, if the spatial distance is greater than a preset distance threshold, it may be determined that the spatial distance is “far”.

Exemplarily, FIG. 10 illustrates a schematic diagram of the neighbouring node at the same partitioning depth and at the same coordinates. As illustrated in FIG. 10, the bold large cube represents the parent node, and the small cube filled with grids in the large cube represents the current node. The intersection position (vertex position) of the current node is illustrated. The small cube filled with white represents the neighbouring node at the same partitioning depth and the same coordinates. The distance between the current node and the neighbouring node is the spatial distance, which may be determined as “close” or “far”. In addition, if the neighbouring node is a plane, the plane position of the neighbouring node is also required.

In this way, as illustrated in FIG. 10, if the current node is a small cube filled with grids, the neighbouring node which is small cube filled with white is found at the same octree partitioning depth level and the same vertical coordinates, and the distance between the two nodes is judged to be “close” or “far”, and the plane position of the node is referred to.

Further, in the embodiments of the present disclosure, FIG. 11 illustrates schematic diagrams of current nodes located at positions of the bottom virtual plane of parent nodes. As illustrated in FIG. 11, (a), (b), (c) illustrates examples of three kinds of current nodes located at the positions of the bottom virtual plane of the parent node. Specific instructions are as follows.

(1) If any one of the child nodes 4 to 7 of the node filled with dots is occupied, but all the nodes filled with grids are not occupied, it is very likely that there is a plane in the current node (filled with slashes), and the plane position is low.

(2) If none of the child nodes 4 to 7 of the node filled with dots is occupied, but any node filled with grids is occupied, it is very likely that there is a plane in the current node (filled with slashes), and the plane position is high.

(3) If the child nodes 4 to 7 of the node filled with dots are all empty nodes, and the nodes filled with grids are all empty nodes, the plane position cannot be inferred, so it is marked as unknown.

(4) If any one of the child nodes 4 to 7 of the node filled points is occupied, and any node filled with grids is occupied, in this case, the plane position cannot be inferred, so it is marked as unknown.

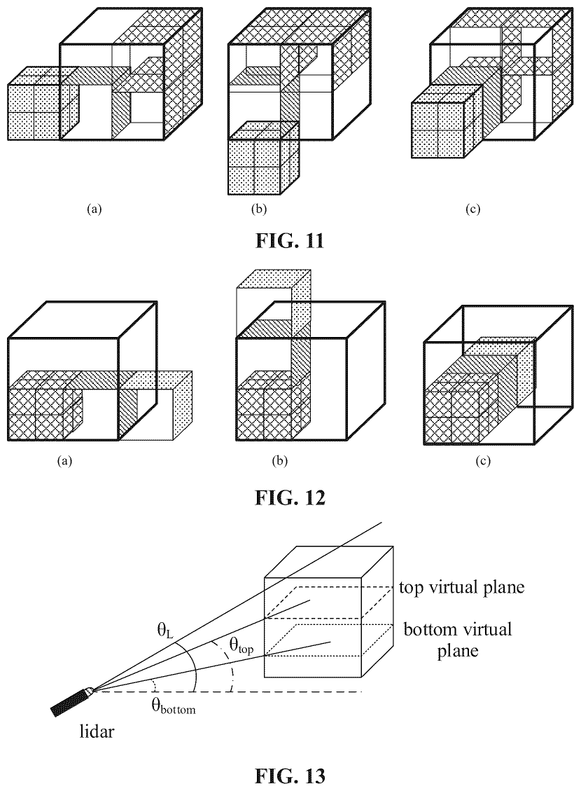

In the embodiments of the present disclosure, FIG. 12 illustrates schematic diagrams of current nodes located at positions of the top virtual plane of parent nodes. As illustrated in FIG. 12, (a), (b), (c) illustrate examples of three kinds of current nodes located at the positions of the top virtual plane of the parent node. The specific explanation is as follows.

(1) If any one of the child nodes 4 to 7 of the node filled with grids is occupied, but the nodes filled with dots are not occupied, it is very likely that there is a plane in the current node (filled with slashes), and the plane position is low.

(2) If none of the child nodes 4 to 7 of the node filled with grids is occupied, but the nodes filled with dots are occupied, it is very likely that there is a plane in the current node (filled with slashes), and the plane position is high.

(3) If the child nodes 4 to 7 of the node filled with grids are all unoccupied, and the nodes filled with dots are unoccupied, in this case, the plane position cannot be inferred, so it is marked as unknown.

(4) If one of the child nodes 4 to 7 of the node filled with grids is occupied, and the nodes filled with dots are occupied, in this case, the plane position cannot be inferred, so it is marked as unknown.

It should also be understood that for the encoding of the plane position information of the lidar point cloud, FIG. 13 illustrates a schematic diagram of prediction encoding of plane position information of the lidar point cloud. As illustrated in FIG. 13, when the emission angle of the lidar is θ_{bottom}, it may be mapped to a bottom virtual plane. When the emission angle of the lidar is θₜₒₚ, it may be mapped to a top virtual plane.

That is, the plane position of the current node is predicted by using the lidar acquisition parameters, and the position is quantized into multiple ranges by using the position where the current node intersects with the lasers, and the multiple ranges finally serve as the context information of the plane position of the current node. The specific calculation process is as follows: assuming that the coordinates of the lidar are (x_{Lidar}, y_{Lidar}, z_{Lidar}) and the geometric coordinates of the current node are (x, y, z), firstly, the vertical tangent value tan θ of the current node relative to the lidar is calculated, and the calculation formula is as follows:

$$tan θ = \frac{z - {z}_{Lidar}}{\sqrt{{( x - {x}_{Lidar} )}^{2} + {( y - {y}_{Lidar} )}^{2}}} \qquad ( 3 )$$

Further, because each laser has a certain offset angle relative to the lidar, it is necessary to calculate the relative tangent value tan θ_{corr,L} of the current node relative to the laser. The specific calculation formula is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 4 )$$

Finally, the relative tangent value tan θ_{corr,L} of the current node can be used to predict the plane position of the current node, and the specific processes are as follows. Assuming that the tangent value of the lower boundary of the current node is tan (θ_{bottom}) and the tangent value of the upper boundary is tan (θₜₒₚ), the plane position is quantized into four quantization ranges according to tan θ_{corr,L}, that is, the context information of the plane position is determined.

However, the OctGeomEnc mode only has an efficient compression rate for the correlated points in space, while for the isolated points in geometric space, using the Direct Coding Model (DCM) can greatly reduce the complexity. For all nodes in the octree, the use of DCM is not represented by flag bit information, but is inferred by the parent node of the current node and neighbour information. There are three ways to determine whether the current node has DCM encoding qualification, as follows:

(1) The current node has no sibling child nodes, that is, the parent node of the current node has only one child node, and the parent node of the parent node of the current node has only two occupied child nodes, that is, the current node has only one neighbouring node at most.

(2) The parent node of the current node has only one occupied child node, that is, the current node, and the six neighbouring nodes that share a plane with the current node are all empty nodes.

(3) The number of sibling nodes of the current node is greater than 1.

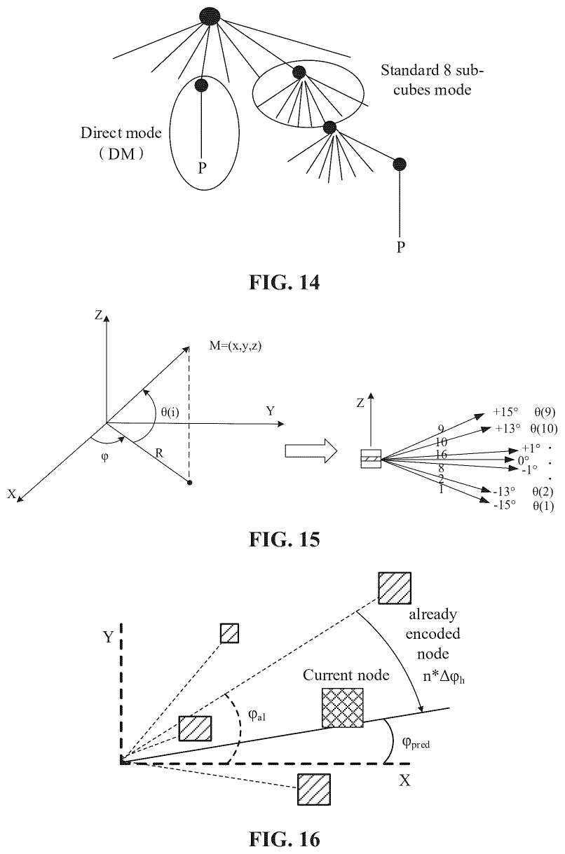

Exemplarily, FIG. 14 provides a schematic diagram of IDCM encoding. If the current node does not have the DCM encoding qualifications, the octree partitioning will be performed on the current node. If the current node has the DCM encoding qualifications, the number of points included in the node will be further determined. When the number of points is less than a threshold (for example, 2), the DCM encoding will be performed on the node. Otherwise, the octree partitioning will be performed continuously. When the DCM encoding mode is applied, it is first necessary to encode whether the current node is a true isolated point, which is denoted as IDCM_flag. When IDCM_flag is true, the current node adopts the DCM encoding, otherwise the current node still adopts the octree encoding. When the current node meets the DCM encoding, it is necessary to encode the DCM encoding mode of the current node. At present, there are two DCM modes, namely: (a) only one point exists (or multiple points, but they are repeated points); (b) two points exist. Finally, it is necessary to encode the respective geometric information of each point. Assuming that the side length of the node is 2^{d}, d bits are needed to encode each component of the geometric coordinates of the node, and this bit information is directly encoded into the bitstream. It should be noted here that when encoding the point cloud of the lidar, the efficiency of the encoding of the geometric information may be further improved by using the lidar acquisition parameters to perform prediction encoding on the coordinate information of three dimensions.

Further, the process of the IDCM encoding will be described in detail below.

When the current node meets the DCM encoding mode, firstly, the number of points numPoints of the current node is encoded. The number of points of the current node is encoded according to different DirectModes.

(1) If the current node does not meet the requirements of the DCM node, it exits directly (i.e. the number of points is greater than 2 points and they are not duplicate points).

(2) If the number of points numPonts included in the current node is less than or equal to 2, the encoding process is as follows:
i) Firstly, whether the numPonts of the current node is greater than 1 is encoded; and
ii) If the current node has only one point and the geometry encoding environment is geometrically lossless encoding, it is necessary to encode that the second point of the current node is not a duplicate point.

(3) If the number of points numPonts included in the current node is greater than 2, the encoding process is as follows:
i) First, it is encoded that the numPonts of the current node is less than or equal to 1.
ii) Secondly, it is encoded that the second point of the current node is a duplicate point, and whether the number of duplicate points of the current node is greater than 1 is encoded. When the number of duplicate points is greater than 1, exponential Golomb decoding needs to be performed on the remaining number of duplicate points.

After the number of points of the current node is encoded, coordinate information of the points included in the current node is encoded. Lidar point clouds and human eye-faced point clouds will be introduced in detail below.

### 1. Human Eye-Faced Point Cloud

(1) If the current node includes only one point, the geometric information of the three dimensional directions of the point will be directly encoded (Bypass coding).

(2) If the current node includes two points, the preferentially encoded coordinate axis dirextAxis will be obtained first by using the geometric coordinates of the points. It should be noted here that the coordinate axes currently compared only include the x-axis and y-axis and do not include the z-axis. Assuming that the geometric coordinates of the current node are nodePos, the determination method is as follows:

$$directAxis = ! ( nodePos [ 0 ] < nodePos [ 1 ] ) \qquad ( 5 )$$

In other words, the axis having a smaller geometric position of the node coordinates is used as the preferentially encoded coordinate axis dirextAxis. Secondly, the geometric information of the preferentially encoded coordinate axis dirextAxis is encoded as follows. Assuming that the to-be-encoded geometric bit depth corresponding to the preferentially encoded axis is nodeSizeLog2, and assuming that the coordinates of the two points are pointPos [0] and pointPos [1], respectively. The specific encoding process is as follows:

```
  Bool sameBit=true;
  while(nodeSizeLog2&& sameBit){
    int mask=1<<nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits); ///<entropy coding
    if(sameBits)
        encodePosBit(bit0);///<Bypass coding
      }
```

After the preferentially encoded coordinate axis dirextAxis is encoded, the geometric coordinates of the current node continue to be directly encoded. Assuming that the remaining encoding bit depth of each point is nodeSizeLog2, the specific encoding process is as follows:

for(int axisIdx=0;axisIdx<3;++axisIdx)
for(int mask=(1<< nodeSizeLog2[axisIdx])>>1;mask;mask>>1)
encodePosBit(!!(pointPos[axisIdx]&mask)).

### 2. Lidar-Faced Point Cloud

If the current node includes two points, the preferentially encoded coordinate axis dirextAxis is obtained first by using the geometric coordinates of the points. Assuming that the geometric coordinates of the current node are nodePos, the determination method is as follows:

$$dirextAxis = ! ( nodePos [ 0 ] < nodePos [ 1 ] )$$

In other words, the axis having a smaller geometric position of the node coordinates is used as the preferentially encoded coordinate axis dirextAxis. It should be noted here that the coordinate axes currently compared only include the x-axis and y-axis and do not include the z-axis. Secondly, the geometric information of the preferentially encoded coordinate axis dirextAxis is encoded in the following manner. Assuming that the to-be-encoded geometric bit depth corresponding to the preferentially encoded axis is nodeSizeLog2, and assuming that the coordinates of the two points are pointPos[0] and pointPos[1], respectively. The specific encoding process is as follows:

```
  Bool sameBit=true;
  while(nodeSizeLog2&& sameBit){
    int mask=1<< nodeSizeLog2;
    −−nodeSizeLog2;
    bool bit0=!!( pointPos[0]& mask)
bool bit1=!!( pointPos[1]& mask)
    sameBits=bit0==bit1;
    entropyCodeSameBit(sameBits);
    if(sameBits)
      encodePosBit(bit0);
    }
```

After the preferentially encoded coordinate axis dirextAxis is encoded, the geometric coordinates of the current node are encoded.

Since the lidar point cloud can obtain the acquisition parameters of the lidar point cloud, the efficiency of the encoding of the geometric information of the point cloud may be further improved by using the geometric coordinate information that can predict the current node. Similarly, firstly, the geometric information nodePos of the current node is used to obtain a directly encoded main axis direction, and secondly, the geometric information of the encoded direction is used to perform prediction encoding on the geometric information of another dimension. Similarly, assuming that the axis direction that is direct encoded is directAxis, and assuming that the to-be-encoded bit depth in the direct encoding is nodeSizeLog2, the encoding method is as follows:

for(int mask=(1<< nodeSizeLog2)>>1;mask;mask>>1);
encodePosBit(!!(pointPos[directAxis]&mask)).

It should be noted here that all the geometric accuracy information in the directAxis direction will be encoded here.

Exemplarily, FIG. 15 provides a schematic diagram of coordinate transform of a point cloud obtained by a rotating lidar. In the Cartesian coordinate system, the coordinates (x, y, z) of each node may be converted to be represented by (R, φ, i). In addition, the Laser Scanner may perform laser scanning at a preset angle, and different θ (i) may be obtained under different values of i. For example, when i is equal to 1, θ(1) may be obtained, and the corresponding scanning angle is −15°. When i is equal to 2, θ(2) may be obtained, and the corresponding scanning angle is −13°. When i is equal to 10, θ(10) may be obtained, and the corresponding scanning angle is +13°. When i is equal to 9, θ(19) may be obtained, and the corresponding scanning angle is +15°.

In this way, after all the precision information in the directAxis coordinate direction is encoded, LaserIdx corresponding to the current point (that is, the pointLaserIdx number in FIG. 15) is calculated first, and the LaserIdx of the current node (that is, nodeLaserIdx) is calculated. Secondly, the LaserIdx of the node (that is, nodeLaserIdx) is used to perform prediction encoding on the LaserIdx of the point (that is, nodeLaserIdx). The calculation method of the LaserIdx of the node or point is as follows. Assuming that the geometric coordinate of the point is pointPos, the starting coordinates of the Laser is LidarOrigin, and assumign that the number of lasers is LaserNum, the tangent value of each Laser is tan θᵢ, and the offset position of each Laser in the vertical direction is Zᵢ, then:

```
      Int bestLaserIdx=0;
    Int Distoration=INT_MAX;
  For(int LaserIdx=0; LaserIdx<numLaser;++ LaserIdx){
int radius = \sqrt{(pointPos[0] − LidarOrigin[0])2 + (pointPos[1] − LidarOrigin[1])2}
    int invRadius=1/ radius
    int Z=pointPos[2]+ Zᵢ
    int tanTheta= Z×invRadius
    if(std::abs(tanTheta-tanθᵢ)< Distoration){
        Distoration= std::abs(tanTheta-tanθᵢ);
        bestLaserIdx= LaserIdx;
        }
      }
```

After calculating the LaserIdx of the current point, firstly, the LaserIdx of the current node is used to perform prediction encoding on the pointLaserIdx of the point. After the LaserIdx of the current point is encoded, the prediction encoding is performed on the geometric information of the three dimensions of the current point by using the acquisition parameters of the lidar.

Exemplarily, FIG. 16 illustrates a schematic diagram of the prediction encoding in an X-axis or Y-axis direction. As illustrated in FIG. 16, boxes filled with grids represent the Current node, and boxes filled with slashes represent the already coded nodes. Here, firstly, the LaserIdx corresponding to the current node is used to obtain the predicted value of the corresponding horizontal azimuth (i.e., φ_{pred}). Secondly, the node geometric information corresponding to the current node is used to obtain the horizontal azimuth φ_{node} corresponding to the node. Assuming that the geometric coordinate of the node is nodePos, the calculation method between the horizontal azimuth p and the node geometric information is as follows:

$$φ = arctan ( nodePos [ 1 ] / nodePos [ 0 ] ) \qquad ( 6 )$$

By using the acquisition parameters of the lidar, the number of rotation points numPoints of each Laser, which denotes the number of points obtained by rotating each Laser once, may be obtained, and the rotational angular velocity deltaPhi of each Laser may be calculated by using the number of rotation points of each Laser. The calculation method is as follows:

$$deltaPhi = \frac{2 π}{numPoints} \qquad ( 7 )$$

Further, the horizontal azimuth prediction value φ_{predPoint} corresponding to the current point (i.e., a prediction value of the horizontal azimuth illustrated in FIG. 17A and FIG. 17B) is calculated by using the horizontal azimuth φ_{node} of the node and the horizontal azimuth φ_{pred} of the previous encoded point of the Laser corresponding to the current point. Here, FIG. 17A illustrates a schematic diagram of a Y-plane angle prediction through the horizontal azimuth, and FIG. 17B illustrates a schematic diagram of an X-plane angle prediction through the horizontal azimuth. Here, for the horizontal azimuth prediction value φ_{predPoint} corresponding to the current point, the calculation method is as follows:

$${φ}_{predPoint} = \frac{φ pred - φ node}{deltaPhi} \times deltaPhi + φ pred \qquad ( 8 )$$

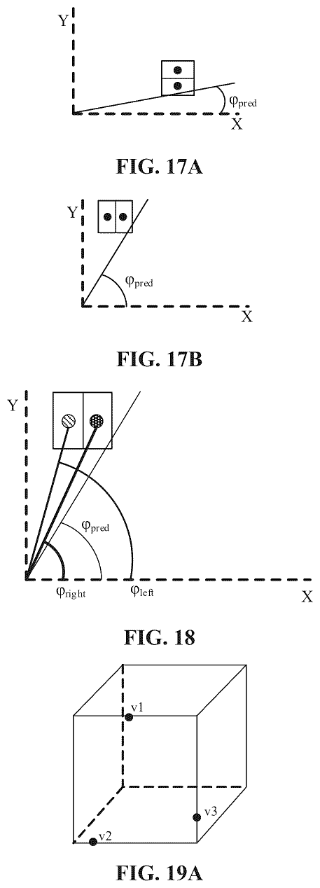

Exemplarily, FIG. 18 illustrates another schematic diagram of the prediction encoding in an X-axis or Y-axis direction. As illustrated in FIG. 18, the portion filled with grids (left side) represents the bottom virtual plane, the portion filled with dots (right side) represents the top virtual plane, φ_{left} denotes the bottom virtual plane horizontal azimuth of the current node, φ_{right} denotes the top virtual plane horizontal azimuth of the current node, and φ_{pred} denotes the horizontal azimuth prediction value corresponding to the current node.

In this way, the prediction encoding is performed on the geometric information of the current node by using the predicted value of the horizontal azimuth φ_{predPoint}, the bottom virtual plane horizontal azimuth φ_{left} of the current node and the top virtual plane horizontal azimuth (pri_{g}ht of the current node. The specific processes are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) \vert \vert ( angLel < 0 \&\& angLeR < 0 ) ? 0 : 2 ;$$

$$int minAngle = std \text{::} min ( abs ( angLel ) , abs ( angLeR ) ) ;$$

$$int maxAngle = std \text{::} max ( abs ( angLel ) , abs ( angLeR ) ) ;$$

$$context += maxAngle > minAngle ? 0 : 1 ;$$

$$context += maxAngle > minAngle ? 0 : 4.$$

After the LaserIdx of the point is encoded, the LaserIdx corresponding to the current point is used to perform the prediction encoding on the Z-axis direction of the current point, that is, the depth information radius of the radar coordinate system is currently calculated by using the x and y information of the current point. Secondly, the laser LaserIdx of the current point is used to obtain the tangent value of the current point and the offset in the vertical direction, so that the predicted value of the Z-axis direction of the current point (i.e., Z_pred) may be obtained. The specific processes are as follows:

$$int radius = \sqrt{{( pointPos [ 0 ] - LidarOrigin [ 0 ] )}^{2} + {( pointPos [ 1 ] - LidarOrigin [ 1 ] )}^{2}} ;$$

$$int tanTheta = tan {θ}_{laserIdx ;}$$

$$int zOffset = {Z}_{laserIdx} ;$$

$$Z\_pred = radius \times tanTheta - zOffset .$$

Further, Z_pred is used to perform prediction encoding on the geometric information in the Z-axis direction of the current point to obtain the prediction residual Z_res, and finally Z_res is encoded.

It should be noted that when the nodes are partitioned into leaf nodes, the number of duplicate points in the leaf nodes needs to be encoded in the case of geometrically lossless encoding. Finally, the occupancy information of all nodes is encoded to generate a binary bitstream. In addition, in the G-PCC, a planar encoding mode is currently introduced. In the process of partitioning the geometry, whether the child nodes of the current node are in the same plane is determined. If the child nodes of the current node meet the conditions of the same plane, the plane will be used to represent the child nodes of the current node.

For the octree geometry decoding, before decoding the occupancy information of each node in the order of breadth-first traversal, the decoding end firstly uses the reconstructed geometric information to determine whether the planar decoding or the IDCM decoding is performed on the current node. If the current node meets the condition of planar decoding, the plane mode information and the plane position information of the current node are firstly decoded, and then the occupancy information of the current node is decoded based on the plane information. If the current node meets the condition of the IDCM decoding, whether the current node is a true IDCM node is decoded. If the current node is a true IDCM node, the DCM decoding mode of the current node will be parsed. Secondly, the number of points in the current DCM node is obtained. Finally, the geometric information of each point is decoded. For nodes that meet neither the planar decoding nor the DCM decoding, the occupancy information of the current node is decoded. The occupancy code of each node is obtained through continuously parsing, and the nodes are continuously partitioned until the partitioning is stopped when the unit cubes of 1×1×1 are obtained by partitioning. The number of points contained in each leaf node is obtained through parsing, and finally the geometric reconstruction point cloud information is recovered.

The process of the IDCM decoding is described in detail below.

Similar to the processing process at the encoding end, firstly, the prior information is used to determine whether to start the IDCM for the node. That is, the starting condition of the IDCM is as follows:

(1) The current node has no sibling child nodes, that is, the parent node of the current node has only one child node, and the parent node of the parent node of the current node has only two occupied child nodes, that is, the current node has only one neighbouring node at most.

(2) The parent node of the current node has only one occupied child node, that is, the current node, and the six neighbouring nodes that share a plane with the current node are all empty nodes.

(3) The number of sibling nodes of the current node is greater than 1.

Further, when the node meets the condition of the DCM encoding, firstly, whether the current node is a true DCM node (that is, IDCM_flag) is determined through decoding. When the IDCM_flag is true, the DCM encoding is used for the current node; otherwise, the octree encoding is used.

Secondly, the number of points numPoints of the current node is obtained through decoding. The specific decoding method is as follows:
i) Firstly, whether the numPonts of the current node is greater than 1 is determined through decoding.
ii) If the numPonts of the current node obtained through decoding is greater than 1, whether the second point is a duplicate point is determined through decoding. If the second point is not a duplicate point, it may be implicitly inferred here that the second type of the DCM mode is met, and the current node includes only two points.
iii) If the numPonts of the current node obtained through decoding is less than or equal to 1, whether the second point is a duplicate point is determined through decoding. If the second point is not a duplicate point, it may be implicitly inferred here that the second type of the DCM mode is met, and the current node includes only one point. If it is obtained through decoding that the second point is a duplicate point, it may be inferred that the third type of the DCM mode is met, and the current node includes multiple points, all of which are duplicate points. Then whether the number of duplicate points is greater than 1 is determined through decoding (entropy decoding). If the number of duplicate points is greater than 1, the number of remaining duplicate points is decoded (decoding by using exponential Columbus).

If the current node does not meet the requirements of the DCM node, it exits directly (i.e. the number of points is greater than 2 and the points are not duplicate points).

After the number of points of the current node is obtained through decoding, the coordinate information of the points included in the current node is obtained through decoding. Lidar point clouds and human eye-faced point clouds will be introduced in detail below.

### 1. Human Eye-Faced Point Cloud

(1) If the current node includes only one point, the geometric information of the three dimensional directions of the point will be directly decoded (Bypass coding).

(2) If the current node includes two points, the preferentially decoded coordinate axis dirextAxis will be obtained first by using the geometric coordinates of the points. It should be noted here that the coordinate axes currently compared only include the x-axis and y-axis, and do not include the z-axis. Assuming that the geometric coordinates of the current node are nodePos, the determination method is as follows:

$$dirextAxis = ! ( nodePos [ 0 ] < nodePos [ 1 ] ) \qquad ( 9 )$$

In other words, the axis having a smaller geometric position of the node coordinates is used as the preferentially decoded coordinate axis dirextAxis. Secondly, the geometric information of the preferentially decoded coordinate axis dirextAxis is decoded as follows. Assuming that the to-be-decoded geometric bit depth corresponding to the preferentially decoded axis is nodeSizeLog2, and assuming that the coordinates of the two points are pointPos [0] and pointPos [1], respectively. The specific coding process is as follows:

```
Bool sameBit=true;
while(nodeSizeLog2&& sameBit){
  pointPos[0][ dirextAxis]<<1;
  pointPos[1][ dirextAxis]<<1;
  −−nodeSizeLog2;
    int bit=0;
    deEntropyCodeSameBit(sameBits); ///<entropy coding
    if(sameBits){
        bit =decodePosBit( );///<Bypass coding
        pointPos[0][ dirextAxis]|= bit
        pointPos[1][ dirextAxis]|= bit
    }else
        pointPos [1] [dirextAxis] |=1///< The reason here is that
      during encoding, two points are sorted in the direction of the
      preferentially encoded axis, so pointPos[0][dirextAxis] <
      pointPos[1][dirextAxis] may be ensured. Therefore, during
      decoding, if the bit information of the two points is different, it
      can be inferred that the bit of the first point is 0 and the bit of the
      second point is 1.
    }
```

After the preferentially decoded coordinate axis dirextAxis is decoded, the geometric coordinates of the current node are continued to be directly decoded. Assuming that the remaining encoding bit depth of each point is nodeSizeLog2, and assuming that the coordinate information of the point is pointPos, the specific decoding process is as follows:

```
for(int axisIdx=0;axisIdx<3;++axisIdx)
for(int idx= nodeSizeLog2[axisIdx]; idx; idx−−){
  pointPos[axisIdx]<<1;
  pointPos[axisIdx]|=decodePosBit( );
    }
```

### 2. Lidar-Faced Point Cloud

If the current node includes two points, the preferentially decoded coordinate axis dirextAxis is obtained firstly by using the geometric coordinates of the points. Assuming that the geometric coordinates of the current node are nodePos, the determination method is as follows:

$$dirextAxis = ! ( nodePos [ 0 ] < nodePos [ 1 ] ) \qquad ( 10 )$$

In other words, the axis having a smaller geometric position of the node coordinates is used as the preferentially decoded coordinate axis dirextAxis. It should be noted here that the coordinate axes currently compared only include the x-axis and y-axis and do not include the z-axis. Secondly, the geometric information of the preferentially decoded coordinate axis dirextAxis is decoded in the following manner. Assuming that the to-be-encoded geometric bit depth corresponding to the preferentially decoded axis is nodeSizeLog2, and assuming that the coordinates of the two points are pointPos[0] and pointPos[1], respectively. The specific coding process is as follows:

```
Bool sameBit=true;
while(nodeSizeLog2&& sameBit){
  pointPos[0][ dirextAxis]<<1;
  pointPos[1][ dirextAxis]<<1;
    −−nodeSizeLog2;
    int bit=0;
    deEntropyCodeSameBit(sameBits); ///<entropy coding
    if(sameBits){
        bit =decodePosBit( );///<Bypass coding
        pointPos[0][ dirextAxis]|= bit
        pointPos[1][ dirextAxis]|= bit
    }else
        pointPos [1] [dirextAxis] |=1///< The reason here is that
      during encoding, two points are sorted in the direction of the
      preferentially encoded axis, so pointPos[0][dirextAxis] <
      pointPos[1][dirextAxis] may be ensured. Therefore, during
      decoding, if the bit information of the two points is different, it
      can be inferred that the bit of the first point is 0 and the bit of the
      second point is 1
    }
```

After the preferentially decoded coordinate axis dirextAxis is decoded, the geometric coordinates of the current node are decoded.

Similarly, firstly, the geometric information nodePos of the current node is used to obtain a directly decoded main axis direction. Secondly, the geometric information of the decoded direction is used to decode the geometric information of another dimension. Similarly, assuming that the directly decoded axis direction is directAxis, and assuming that the to-be-decoded bit depth in direct decoding is nodeSizeLog2, the decoding method is as follows:

```
for(int idx= nodeSizeLog2[directAxis]; idx; idx−−){
  pointPos[directAxis]<<1;
  pointPos[directAxis]|=decodePosBit( );
    }
```

It should be noted here that all the geometric accuracy information of the directAxis direction will be decoded here.

After all the accuracy of the directAxis coordinate direction is decoded, firstly, the LaserIdx of the current node, (i.e., nodeLaserIdx) will be calculated. Secondly, the LaserIdx of the node (i.e., nodeLaserIdx) will be used to perform prediction decoding on the LaserIdx of the point (i.e., pointLaserIdx). The calculation method of the LaserIdx of the node or point is the same as that in the encoding end. Finally, the LaserIdx of the current node and the LaserIdx prediction residual information of the node are decoded to obtain ResLaserIdx, and the decoding method is as follows:

$$PointLaserIdx = nodeLaserIdx + ResLaserIdx \qquad ( 11 )$$

After the LaserIdx of the current point is decoded, the prediction decoding is performed on the geometric information of the three dimensions of the current point by using the acquisition parameters of the lidar. The specific algorithm is as follows:

As illustrated in FIG. 11, firstly, the LaserIdx corresponding to the current node is used to obtain the predicted value of the corresponding horizontal azimuth (i.e., φ_{pred}). Secondly, the node geometric information corresponding to the current node is used to obtain the horizontal azimuth φ_{node} corresponding to the node. Assuming that the geometric coordinate of the node is nodePos, the calculation method between the horizontal azimuth Y and the node geometric information is as follows:

$$φ = arctan ( nodePos [ 1 ] / nodePos [ 0 ] ) \qquad ( 12 )$$

By using the acquisition parameters of the lidar, the number of rotation points numPoints of each Laser, which denotes the number of points obtained by rotating each Laser once, may be obtained, and the rotational angular velocity deltaPhi of each Laser may be calculated by using the number of rotation points of each Laser. The calculation method is as follows:

$$deltaPhi = \frac{2 π}{numPoints} \qquad ( 13 )$$

Further, the horizontal azimuth prediction value φ_{predPoint} corresponding to the current point (i.e., a prediction value of the horizontal azimuth illustrated in FIG. 17A and FIG. 17B) is calculated by using the horizontal azimuth φ_{node} of the node and the horizontal azimuth φ_{pred} of the previous encoded point of the Laser corresponding to the current point. The calculation method is as follows:

$${φ}_{predPoint} = \frac{φ pred - φnode}{deltaPhi} \times deltaPhi + φ pred \qquad ( 14 )$$

In this way, the prediction decoding is performed on the geometric information of the current node by using the predicted value of the horizontal azimuth φ_{predPoint}, the bottom virtual plane horizontal azimuth φ_{left} of the current node and the top virtual plane horizontal azimuth φ_{right} of the current node. The specific processes are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) ‖ ( angLel < 0 \&\& angLeR < 0 ) ? 0 : 2 ;$$

$$int abs AngleL = abs ( angLel ) ;$$

$$int abs AngleR = abs ( angLeR ) ;$$

$$context += abs AngleL > abs AngleR ? 0 : 1 ;$$

$$context += max Angle > min Angle ≪ 1 ? 4 : 0.$$

After the LaserIdx of the point is decoded, the LaserIdx corresponding to the current point is used to perform the prediction decoding on the Z-axis direction of the current point. That is, the depth information radius of the radar coordinate system is currently calculated by using the x and y information of the current point, and secondly, the laser LaserIdx of the current point is used to obtain the tangent value of the current point and the offset in the vertical direction, so that the predicted value of the Z-axis direction of the current point (i.e., Z_pred) may be obtained. The specific processes are as follows:

$$int radius = \sqrt{( pointPos [ 0 ] - LidarOrigin [ 0 ] ) 2 + ( pointPos [ 1 ] - LidarOrigin [ 1 ] ) 2} ;$$

$$int tan Theta = tan {θ}_{laserIdx} ;$$

$$int zOffset = {Z}_{laserIdx} ;$$

$$Z\_pred = radius \times tan Theta - zOffset .$$

Further, Z_res and Z_pred obtained through decoding are used to reconstruct and restore the geometric information of the Z-axis direction of the current point.

For geometric information encoding based on triangle soup (trisoup), in the geometric information coding framework based on trisoup, geometric partitioning should also be performed first, but it is different from the geometric information encoding based on binary tree/quadtree/octree. This method does not need to partition the point cloud into unit cubes with a side length of 1×1×1 step by step, but to stop partitioning when the side length of sub-blocks is W. Based on the surface formed by the distribution of point clouds in each block, at most twelve intersections (vertexes) generated by the surface and the twelve edges of the block are obtained. The vertex coordinates of each block are encoded in turn to generate a binary bitstream.

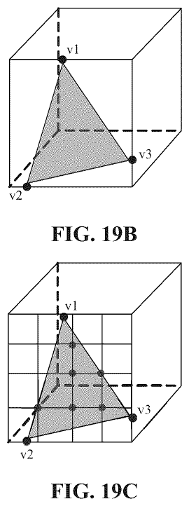

For the point cloud geometric information reconstruction based on the trisoup, when the point cloud geometric information reconstruction is performed at the decoding end, the vertex coordinates are firstly obtained through decoding to complete the reconstruction of the trisoup, and the process is illustrated in FIG. 19A, FIG. 19B and FIG. 19C. There are three vertexes (v1, v2, v3) in the block illustrated in FIG. 19A, and the trisoup is formed by using these three vertexes in a certain order, as illustrated in FIG. 19B. Thereafter, sampling is performed on the trisoup, and the obtained sampling points are used as the reconstructed point cloud in the block, as illustrated in FIG. 19C.

The Predictive geometry coding (PredGeomTree) includes the following operations. Firstly, the input point cloud is sorted. Currently used sorting methods include disorder, Morton order, azimuth order and radial distance order. At the encoding end, the prediction tree structure is established in two different manners, including: KD-Tree (high delay slow mode) and low delay fast mode (calibrating information by using lidars). When calibrating information by using lidars, each point is partitioned into different lasers, and the prediction tree structure is established according to different lasers. Next, based on the prediction tree structure, each node in the prediction tree is traversed, and the geometric position information of the node is predicted by selecting different prediction modes to obtain the prediction residual. The geometric prediction residual is quantized by using quantization parameters. Finally, through the continuous iteration, the prediction residual, prediction tree structure and quantization parameters of the node position information in the prediction tree are encoded to generate the binary bitstream.

For geometry decoding based on the prediction tree, the decoding end reconstructs the prediction tree structure by continuously parsing the bitstream. Then the geometric position prediction residual information and quantization parameters of each prediction node are obtained through parsing, and inverse quantization is performed on the prediction residual to restore the reconstructed geometric position information of each node. Finally, the geometric reconstruction at the decoding end is completed.

After the geometry encoding is completed, the geometric information needs to be reconstructed. At present, the attribute coding is mainly performed for the colour information. Firstly, the colour information is converted from the RGB colour space to the YUV colour space. Then, the point cloud is recoloured by using the reconstructed geometric information so that the unencoded attribute information corresponds to the reconstructed geometric information. In the encoding of the colour information, there are mainly two transform methods. A first transform method is distance-based lifting transformation that relies on the LOD partitioning, and a second transform method is the direct RAHT. Both methods will convert the colour information from the spatial domain to the frequency domain and obtain the high-frequency coefficients and the low-frequency coefficients through transform. Finally, the coefficients are quantized and encoded to generate a binary bitstream. Reference can be made to FIG. 4A and FIG. 4B for details.

Further, when the attribute information is predicted by using the geometric information, the nearest neighbouring search may be performed by using the Morton code, and the Morton code corresponding to each point in the point cloud may be obtained from the geometric coordinates of the point. The specific method for calculating the Morton code is described as follows. For three-dimensional coordinates represented by d-bit binary numbers of each component, the three components may be expressed as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} \qquad ( 15 )$$

Here, [symbol] , [symbol] , [symbol] ∈{0,1} are the binary values corresponding to the highest bit ( [symbol] =1) to the lowest bit ( [symbol] =x, y and z, respectively. For the Morton code M, [symbol] , [symbol] , [symbol] are in turn crosswise arranged starting from the highest bit to the lowest bit for x, y and z. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 16 )$$

Here, [symbol] ∈{0,1} are the values from the highest bit ( [symbol] =1) to the lowest bit ( [symbol] =3d) of M, respectively. After the Morton code M of each point in the point cloud is obtained, the points in the point cloud are arranged in ascending order of the Morton codes, and the weight value w of each point is set to 1.

It is also understood that for the G-PCC encoding and decoding framework, the general test conditions are as follows.

(1) There are 4 kinds of test conditions:
Condition 1: the geometric position is limited lossy, and the attributes are lossy;
Condition 2: the geometric position is lossless, and the attributes are lossy;
Condition 3: the geometric position is lossless, and the attributes are limited lossy;
Condition 4: the geometric position is lossless, and attributes is lossless.

(2) The general test sequence includes four categories: Cat1A, Cat1B, Cat3-fused, and Cat3-frame. The Cat2-frame point cloud only includes the reflectance attribute information. The Cat1A and Cat1B point clouds only include the colour attribute information. The Cat3-fused point cloud includes both the colour attribute information and the reflectance attribute information.

(3) There are two kinds of technical routes in total, which are distinguished by the algorithms used in the geometric compression.

### First Technical Route: Octree Encoding Branch

At the encoding end, the bounding box is partitioned continuously to obtain the sub-cubes, and the non-empty sub-cubes (including points in the point cloud) are continuously partitioned until the partitioned leaf nodes are 1×1×1 unit cubes. In the case of the geometrically lossless encoding, the number of points included in the leaf nodes needs to be encoded. Finally, the geometric octree encoding is completed to generate a binary bitstream.

At the decoding end, the decoding end obtains the occupancy code of each node through continuously parsing in the order of breadth-first traversal, and the nodes are continuously partitioned until the unit cube of 1×1×1 is obtained. In the case of the geometrically lossless decoding, the number of points contained in each leaf node needs to obtained by parsing. Finally, the geometric reconstruction point cloud information is obtained.

### Second Technical Route: Prediction Tree Encoding Branch

At the encoding side, the prediction tree structure is established in two different ways, including: based on KD-Tree (high delay slow mode) and calibrating information by using lidars (low delay fast mode). When calibrating information by using the lidars, each point is partitioned into different lasers, and the prediction tree structure is established according to different lasers. Next, based on the prediction tree structure, each node in the prediction tree is traversed, and the geometric position information of the node is predicted by selecting different prediction modes to obtain the prediction residual. The geometric prediction residual is quantized by using the quantization parameters. Finally, through the continuous iteration, the prediction residual, prediction tree structure and quantization parameters of node position information in prediction tree are encoded to generate the binary bitstream.

At the decoding end, the decoding end reconstructs the prediction tree structure by continuously parsing the bitstream. Then the geometric position prediction residual information and quantization parameters of each prediction node are obtained through parsing, and inverse quantization is performed on the prediction residual to restore the reconstructed geometric position information of each node. Finally, the geometric reconstruction at the decoding end is completed.

It should also be noted that, as illustrated in FIG. 4A or FIG. 4B, the current G-PCC encoding framework includes three attribute encoding methods: the Predicting Transform (PT), the Lifting Transform (LT) and the Region Adaptive Hierarchical Transform (RAHT). In the first two mode, the prediction encoding is performed on the point cloud based on the generation order of the LOD, while in the RAHT mode, the attribute information is adaptively transformed from the bottom to the top according to the construction level of the octree. These three encoding methods for the attributes of the point cloud will be described in detail below.

### (a) Prediction Encoding of the Attribute Information of the Point Cloud

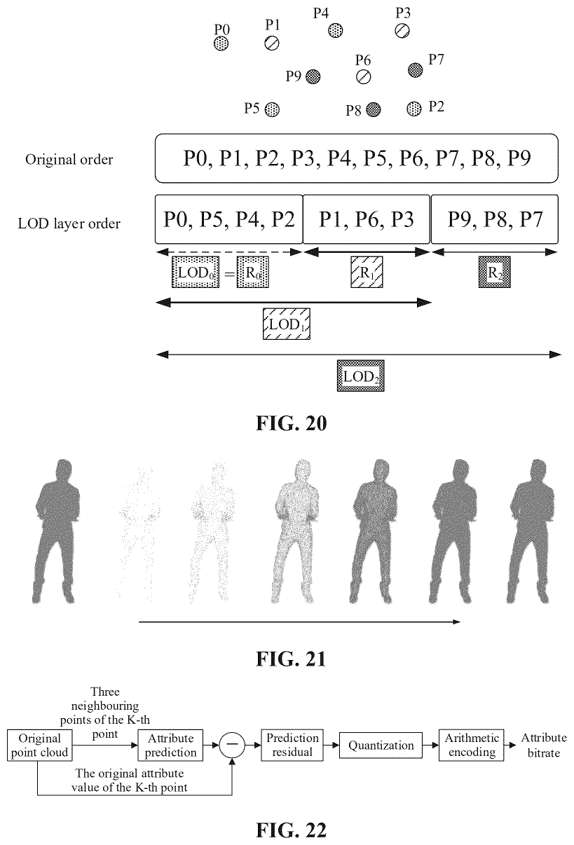

At present, the attribute prediction module of the G-PCC adopts a nearest neighbouring attribute prediction encoding scheme based on Level-of-details (LoDs) structure. The construction methods of the LOD include a distance-based LOD construction scheme, a fixed sampling rate-based LOD construction scheme, an octree-based LOD construction scheme, and the like. In the distance-threshold-based LOD construction scheme, sorting of the Mortons is performed on the point cloud before constructing the LOD to ensure a strong attribute correlation between neighbouring points. FIG. 20 is a schematic diagram of a distance-based LOD construction process. As illustrated in FIG. 20, according to the L Manhattan distances (d) preset by the user in advance (l=0, 1, . . . L−1), the point cloud is partitioned into L different point cloud detail layers (Rl) (l=0, 1, . . . L−1). Here, (d) (1=0, 1, . . . L−1) meets dl<dl−1. The construction process of the LOD is described below.

(1) Firstly, all the points in the point cloud are marked as unvisited, and a set V is established to store the visited point sets. (2) For each iteration of l, by traversing the points in the point cloud, the point is ignored if it has been visited. Otherwise the minimum distance D between the current point and the point set V is calculated. The point is ignored if D<dl. Otherwise, the current point is marked as having been visited and the current point is added to the refinement layer Rl and the point set V. (3) The points in the level-of-detail LOD/are composed of points in the refinement layers R0, R1, R2 . . . Rl. (4) The above operations are repeated continuously until all the points are marked as having been visited.

On the basis of the structure of the LOD, the attribute value of each point is linearly weighted predicted by using the reconstructed attribute value of the point in the LOD of the same layer or an upper layer. The maximum number of the reference prediction neighbourings is determined by the high-layer syntax element of the encoder. For the attributes of each point, at the encoding end, rate distortion optimization algorithm is used to select the attributes of N nearest neighbouring points to perform the weighted prediction or select the attribute of a single nearest neighbouring point to perform the prediction. Finally, the selected prediction mode and prediction residual are encoded.

$${{Attr}_{i}}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} ) \qquad ( 17 )$$

Here, N denotes the number of prediction points in the nearest neighbouring point set of the point i. Pi denotes the combination of N nearest neighbouring points of the point i. Dm denotes the spatial geometric distance between the nearest neighbouring point m and the current point i. Attrm denotes the reconstructed attribute value of the nearest neighbouring point m. Attrᵢ′ denotes the attribute predicted value of the current point i, and the number N of points is a preset value.

In order to trade off the attribute encoding efficiency and the parallel processing between different LOD layers, a switch is introduced in the upper layer syntax element of the encoder to control whether to introduce the LOD intra-layer prediction. If the switch is on, the LOD intra-layer prediction is started, and points within the same LOD layer may be used for the prediction. It should be noted that the LOD intra-layer prediction is always used when the number of the LOD layer is 1.

FIG. 21 is a schematic diagram of a visualization result of a LOD generation process. As illustrated in FIG. 21, a subjective example of a distance-based LOD generation process is provided here. Specifically (from left to right), the points in the first layer represent the outer contour of the point cloud, and with the increase of detail layer, the description of the detail of the point cloud gradually becomes clear.

FIG. 22 is a schematic diagram of an encoding flow of attribute prediction. As illustrated in FIG. 22, regarding the specific processes of the G-PCC attribute prediction, for the original point cloud, firstly, three neighboring points of the K-th point are searched, and then the attribute prediction is performed. According to the difference between the attribute prediction value of the K-th point and the original attribute value of the K-th point, the prediction residual of the K-th point may be obtained. Then, the quantization and arithmetic encoding are performed, and the attribute code rate is generated.

### (i) Selection of an Optimal Prediction Value

After the LOD is constructed, according to the generation sequence of the LOD, firstly, the three nearest neighbouring points of the current point to-be-encoded are found from the encoded data points. The reconstructed attribute values of the three nearest neighbouring points are taken as the candidate prediction values of the current point to-be-encoded. Then, the optimal prediction value is selected according to Rate-Distortion Optimization (RDO). For example, when encoding the attribute value of the point P2 in FIG. 20, the index of the prediction variable of the attribute value of the nearest neighbouring point P4 is set to 1. The indexes of the prediction variable of the attribute value of the next nearest neighbouring point P5 and the third nearest neighbouring point P0 are set to 2 and 3, respectively. The index of the prediction variable of the weighted average of the points P0, P5, and P4 is set to 0, as illustrated in Table 1. Finally, the optimal prediction variable is selected by using RDO. The formula for the weighted average is as follows:

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} ) \qquad ( 18 )$$

Here, \tilde{w}ᵢⱼ denotes the spatial geometry weight of the neighbouring point j to the current point i.

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} \qquad ( 19 )$$

âᵢ denotes the attribute prediction value of the current point i. j denotes the index of the three neighboring points. ãⱼ denotes the attribute value after the reconstruction of the neighbouring point. xᵢ, yᵢ, zᵢ are the geometric position coordinates of the current point i. xᵢⱼ, yᵢⱼ, zᵢⱼ are the geometric coordinates of the neighboring point j.

Exemplarily, Table 1 provides an example sample of candidate prediction values in an attribute encoding.

TABLE 1

| Prediction | |
|---|---|
| Mode | Prediction Value |
| 0 | Weighted average of the attributes of the three nearest |
| | neighbouring points |
| 1 | P4 (the attribute value of the first nearest neighbouring) |
| 2 | P5 (the attribute value of the second nearest neighbouring) |
| 3 | P0 (the attribute value of the third nearest neighbouring) |

### (ii) Attribute Prediction Residuals and Quantization

The attribute prediction value (âᵢ)_{i∈0 . . . k-1} (k is the total number of the points in the point cloud) of the current point i is obtained through the above prediction. Let (aᵢ)_{i∈0 . . . k-1} be the original value of the attribute of the current point, and the attribute residual (rᵢ)_{i∈0 . . . k-1} is:

$${r}_{i} = {a}_{i} - {\hat{a}}_{i} \qquad ( 20 )$$

The prediction residual is further quantized:

$${Q}_{i} = \frac{{r}_{i}}{Qs} \qquad ( 21 )$$

Here, Qᵢ denotes the quantized attribute residual of the current point i. Qs denotes a Quantization step (Qs), which may be calculated through a Quantization Parameter (QP) specified by the CTC.

(iii) the Encoding End Reconstructs the Attribute Values

The purpose of reconstruction at the encoding end is for the prediction of subsequent points. Before reconstructing the attribute value, the residual should be inversely quantized. \hat{r}ᵢ denotes the inversely quantized residual:

$${\hat{r}}_{i} = {Q}_{i} \times Qs \qquad ( 22 )$$

\hat{r}ᵢ is added to the prediction value âᵢ to obtain the reconstructed value ãᵢ of the point i:

$${\tilde{a}}_{i} = {\hat{r}}_{i} + {\hat{a}}_{i} \qquad ( 23 )$$

At present, there are two kinds of algorithms for the attribute nearest neighbouring search based on the LOD partition: the intra nearest neighbouring search and the inter nearest neighbouring search. The inter nearest neighbouring search algorithm is as follows. The intra nearest neighbouring search may be classified into two algorithms: inter-layer nearest neighbouring search and intra-layer nearest neighbouring search.

### (i) Intra Nearest Neighbouring Search

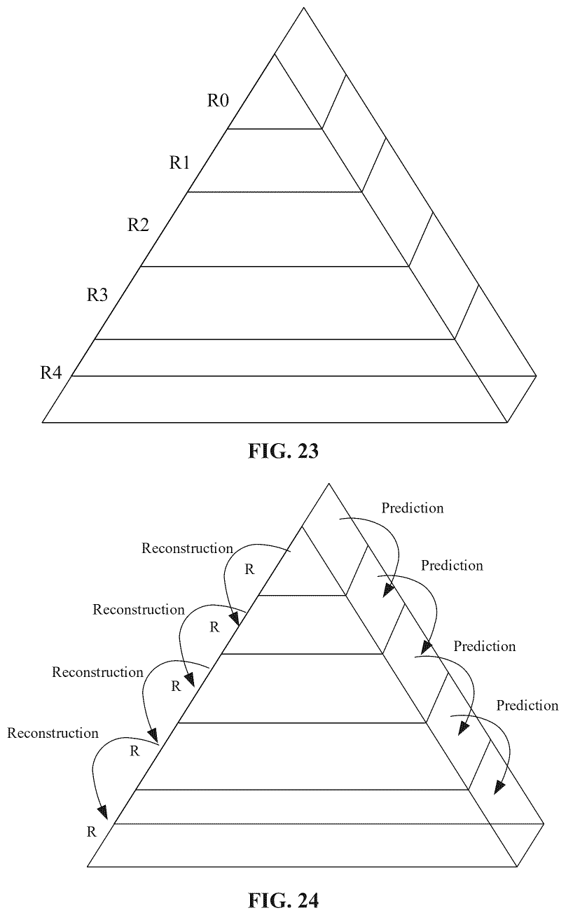

Intra nearest neighbouring search is classified into two algorithms: inter-layer nearest neighbouring search and intra-layer nearest neighbouring search. A pyramid structure is obtained after the LOD partition, as illustrated in FIG. 23.

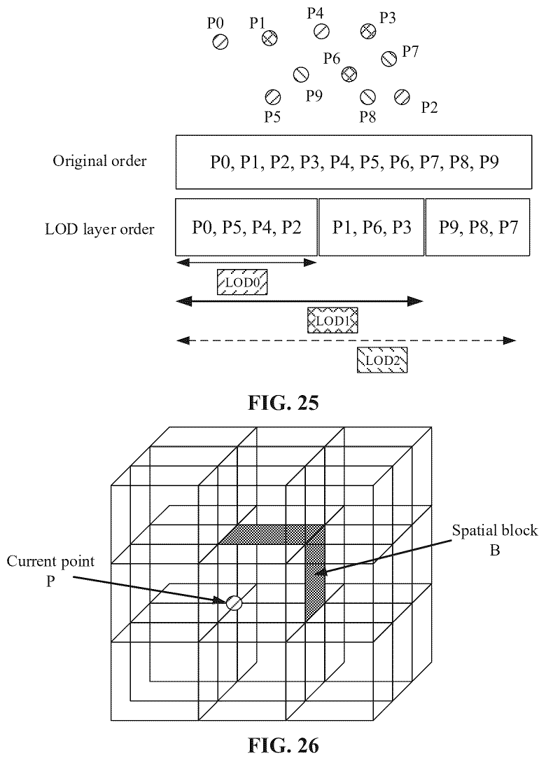

In a specific implementation, the pyramid structure is illustrated in FIG. 24 for the inter-layer nearest neighbouring search. FIG. 25 is a schematic diagram of an LOD construction process for the inter-layer nearest neighbouring search. As illustrated in FIG. 25, different LOD layers are obtained based on geometric information partition, and LOD0, LOD1 and LOD2 are obtained. The points in the LOD0 are used to predict the attributes of the points in the next LOD layer in the process of the inter-layer nearest neighbouring search.

The entire processes of the intra nearest neighbouring search will be introduced in detail below.

Throughout the process of the LOD partition, there are three sets O(k), L(k), and I(k). Here, k is the index of the LOD layer for the LOD partition, and I(k) is the input point set for the current LOD partition. After the LOD partition, an O(k) set and an L(k) set are obtained. The sampling point set is stored in the O(k) set, and L(k) is the point set in the current LOD layer. That is, the entire LOD partition processes are as follows:
(1) Initialization

$$if k = 0 , L ( k ) ← \{ \} ; otherwise , L ( k ) ← L ( k - 1 ) ;$$

$$O ( k ) ← \{ \} ;$$

(2) The sampling points are stored in O(k) by using the LOD partition algorithm, and the rest points are stored in L(k); and
(3) When performing the next iteration, I←O(k).

It should be noted here that since the entire LOD partition process is performed based on the Morton code, O(k), L(k), and I(k) store the indexes of Morton codes corresponding to the points.

When performing the inter-layer nearest neighbouring search (that is, the nearest neighbouring search is performed in the O(k) set for the points within the L(k) set), the specific search algorithm is as follows.

Taking the nearest neighbouring search based on the spatial relationship as an example, when prediction is performed for the current point P, the neighbouring search is performed by using the parent block (Block B) corresponding to the point P. As illustrated in FIG. 26, the points in the coplanar and collinear neighbouring blocks with the current parent block are searched to perform the attribute prediction.

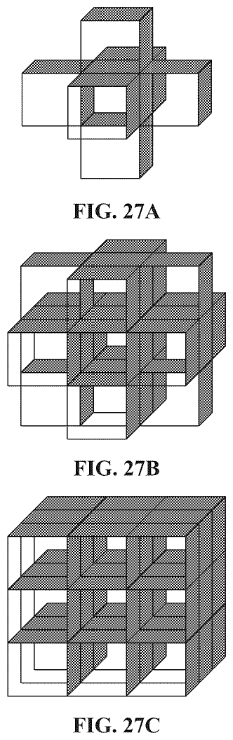

FIG. 27A illustrates a schematic diagram of a coplanar spatial relationship. There are a total of 6 spatial blocks having a relationship with the current parent block. FIG. 27B illustrates a schematic diagram of a coplanar and collinear spatial relationship. There are a total of 18 spatial blocks having a relationship with the current parent block. FIG. 27C illustrates a schematic diagram of a coplanar, collinear, and concurrent spatial relationship. There are a total of 26 spatial blocks having a relationship with the current parent block.

Firstly, the corresponding spatial block is obtained by using the coordinates of the current point. Secondly, the nearest neighbouring search is performed in the previously encoded LOD layer, and the spatial block coplanar, collinear and concurrent with the current block is searched to obtain the N nearest neighbours of the current point.

When the N nearest neighbours of the current point are still not obtained after the coplanar, collinear and concurrent nearest neighbouring search, the N nearest neighbours of the current point will be obtained based on the fast search algorithm. The specific algorithm is as follows.

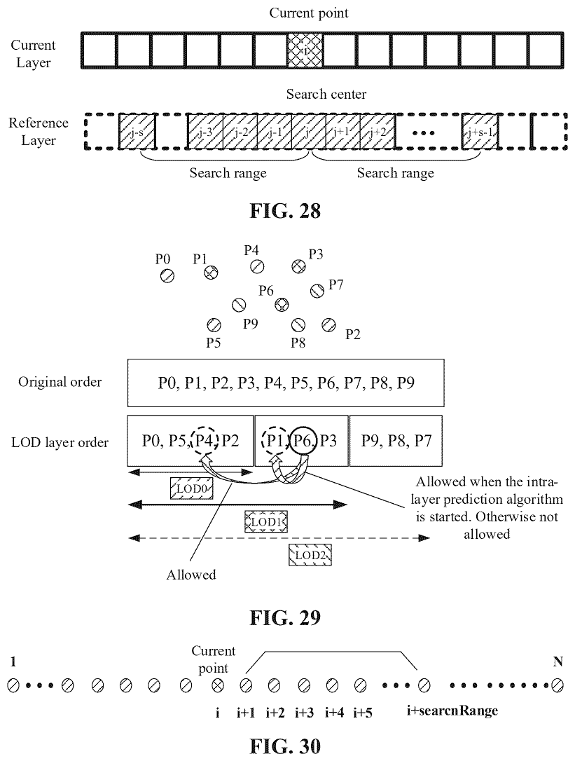

As illustrated in FIG. 28, when the attribute inter-layer prediction is performed, firstly, the Morton code corresponding to the current point is obtained by using the geometric coordinates of the current point to-be-encoded. Secondly, the first reference point (j) in the reference frame that has a greater Morton code than the current point is found based on the Morton code of the current point, and the nearest neighbouring search is performed within the range of [j−searchRange, j+searchRange].

Other specific algorithms for updating the nearest neighbours are consistent with the inter nearest neighbouring search algorithm, and will not be described in detail here. The specific algorithms will be mentioned in the inter nearest neighbouring search algorithm.

In another specific implementation, for the intra-layer nearest neighbouring search, FIG. 29 illustrates a schematic diagram of an LOD structure of the nearest neighbouring search in an attribute layer. As illustrated in FIG. 29, if the intra-layer prediction algorithm is enabled (i.e., the syntax element EnableRefferingSameLoD=1), the nearest neighbouring search within the layer may be allowed. For example, for the LOD1 layer, the nearest neighbouring point of the current point P6 may be P1, and other layers are not allowed. If the syntax element EnableRefferingSameLoD=0, the inter-layer search is allowed in other layers. For example, for the LOD1 layer, the nearest neighbouring point of the current point P6 may be P4. In other words, when the intra-layer prediction algorithm is enabled, the nearest neighbouring search will be performed in the encoded point set of the same layer within the same LOD layer to obtain the N nearest neighbours of the current point (the inter-layer nearest neighbouring search will also be performed).

When the attribute intra-layer prediction is performed, the nearest neighbouring search is performed based on the fast search algorithm. The specific algorithm is illustrated in FIG. 30. The current point is represented by grids. Assuming that the index of the Morton code of the current point is i, the nearest neighbouring search will be performed in [i+1, i+searchRange]. The specific nearest neighbouring search algorithm is consistent with the inter block-based fast search algorithm, which will not be described in detail here.

### (ii) Inter Nearest Neighbouring Search

FIG. 28 is a schematic diagram of an attribute inter-prediction. As illustrated in FIG. 28, when the attribute inter-prediction is performed, firstly, the Morton code corresponding to the current point is obtained by using the geometric coordinates of the current point to-be-encoded. Secondly, the first reference point (j) in the reference frame that has a greater Morton code than the current point is found based on the Morton code of the current point, and the nearest neighbouring search is performed within the range of j−searchRange, j+searchRange].

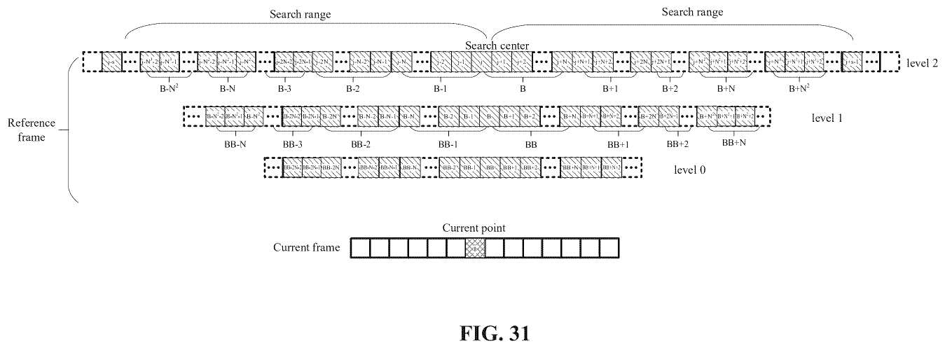

At present, when performing the intra and inter nearest neighbouring search, the neighbouring search is performed based on the block, and reference can be made to FIG. 31 for details. As illustrated in FIG. 31, when performing the neighbouring search on the current point (index of Morton code is i), the points in the reference frame are firstly divided into N (N=3) layers according to the Morton codes. The specific division algorithm is as follows:
The first layer: assuming that the points of the reference frame are numPoints, firstly the points in the reference frame are divided into blocks, with M (M=2⁵=32) points per block;
The second layer: based on the first layer, similarly, the blocks of the first layer are also divided into blocks in the order of Morton codes, with M (M=2⁵=32) blocks per block;
The third layer: based on the second layer, similarly, the blocks of the first layer are also divided into blocks in the order of Morton codes, with M (M=2⁵=32) blocks per block;

Finally, the prediction structure illustrated in FIG. 31 is obtained.

The attribute prediction is performed based on the prediction structure illustrated in FIG. 31. Assuming that the index of Morton code of the current point to-be-encoded is i, the first point in the reference frame that has the Morton code greater than or equal to the Morton code of the current point is firstly obtained, and the index is j. Secondly, the block index of the reference point is calculated based on i, and the specific calculation method is as follows:

$$First layer : BucketSize\_ 0 = {2}^{5} = 32 ;$$

$$Second layer : BucketSize\_ 1 = {2}^{5} = 32 \times BucketSize\_ 0 = 1024 ;$$

$$Third layer : BucketSize\_ 2 = {2}^{5} = 32 \times BucketSize\_ 1 = 32768 .$$

Assuming that the reference range in the prediction frame of the current point is j−searchRange, j+searchRange], the starting index of the third layer is calculated by using the j−searchRange, and the termination index of the third layer is calculated by using the j+searchRange. Then, firstly, in the blocks of the third layer, it is determined whether the nearest neighbouring search needs to be performed for some blocks of the second layer. Secondly, in the second layer, it is determined whether the search needs to be performed for each block of the first layer. If the nearest neighbouring search needs to be performed for some blocks of the first layer, determination will be performed point by point for some points in the blocks of the first layer to update the nearest neighbour.

Hereafter, the algorithm of calculating blocks based on index is introduced. Assuming that the index of the Morton code corresponding to the current point is index, the index of the corresponding block of the third layer is:

$$Idx\_ 2 = index / BucketSize\_ 2 \qquad ( 24 )$$

After obtaining the index idx_2 of the block of the third layer, the starting index and the termination index of the block corresponding to the current block of the second layer may be obtained by using idx_2:

$$startIdx 1 = idx\_ 2 \times BucketSize\_ 1 \qquad ( 25 )$$

$$endIdx = idx\_ 2 \times BucketSize\_ 1 + BucketSize\_ 1 ‐ 1 \qquad ( 26 )$$

Similarly, based on the same algorithm, the index of the block of the first layer is obtained based on the index of the block of the second layer.

When performing the nearest neighbouring search based on the blocks, firstly, it is determined whether the nearest neighbouring search needs to be performed for the current block, that is, the nearest neighbouring search of the block is filtered. Two variables minPos and maxPos may be obtained for each spatial block. minPos denotes the minimum value of the block, and maxPos denotes the maximum value of the block.

It is assumed that the distance of the farthest point among the N nearest neighbours searched for the current point is Dist, the coordinates of the to-be-encoded point are (x, y, z), and the current block is represented as (minPos, maxPos). Here, minPos is the minimum value on three dimensions of the bounding box and maxPos is the maximum value on three dimensions of the bounding box, the distance D between the current point and the bounding box is calculated as follows:

$$int dx = int ( std \text{::} max ( std \text{::} max ( min Pos [ 0 ] - point [ 0 ] , 0 ) , point [ 0 ] - max Pos [ 0 ] ) ) ;$$

$$int dy = int ( std \text{::} max ( std \text{::} max ( min Pos [ 1 ] - point [ 1 ] , 0 ) , point [ 1 ] - max Pos [ 1 ] ) ) ;$$

$$int dz = int ( std \text{::} max ( std \text{::} max ( min Pos [ 2 ] - point [ 2 ] , 0 ) , point [ 2 ] - max Pos [ 2 ] ) ) ;$$

$$D = dx + dy + dz ;$$

When D is less than or equal to Dist, the points in the current block will be traversed.

### (b) Lifting Transform Encoding of Point Cloud Attribute Information.

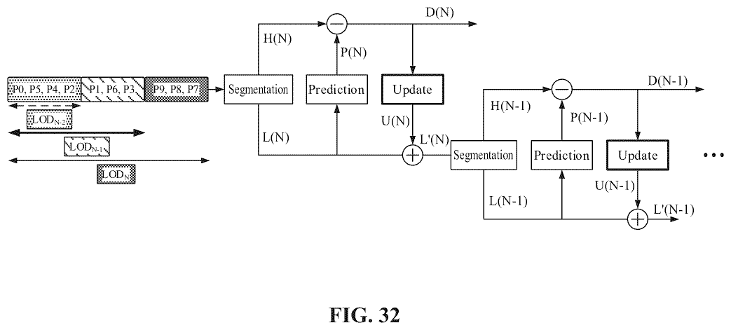

FIG. 32 is a schematic diagram of an encoding flow of a lifting transform. In the lifting transform, prediction encoding is also performed on the attribute of the point cloud based on the LOD. The difference from the prediction transform is that in the lifting transform, the LOD is firstly partitioned into high and low layers, prediction is performed according to the reverse order of the generation of the layers of the LOD, and an update operator is introduced in the prediction process to update the quantization weight of the point in the low-layer LOD, so as to improve the accuracy of prediction. This is because the attribute value of the points in the low-layer LOD will be frequently used to predict the attribute value of the points in the high-layer LOD, and the points in the low-layer LOD should have greater influence.

### Step 1: Segmentation Process.

The segmentation process is to divide the complete LOD layer into a low LOD layer L(N) and a high LOD layer H(N). If a point cloud has three layers of LOD (that is, (LODₗ)_{l=0,1,2}), after the segmentation, LOD₂ is a high LOD layer and is denoted as H(N), and (LODₗ)_{l=0,1} is a low LOD layer and is denoted as L(N).

### Step 2: Prediction Process

The point in the high layer LOD selects the attribute information of the nearest neighbouring point from the low layer as the attribute prediction value P(N) of the current to-be-encoded point, and the prediction residual D(N) is denoted as:

$$D ( N ) = H ( N ) - P ( N ) \qquad ( 27 )$$

### Step 3: Update Process

The attribute prediction residual D(N) in the high-layer LOD is updated to obtain U(N), and the attribute value of the point in the low-layer LOD is lifted by using U(N), as shown in the following formula:

$${L}^{′} ( N ) = L ( N ) + U ( N ) \qquad ( 28 )$$

The above processes will be iterated continuously to the lowest layer LOD according to the order of LOD from high to low.

Because the LOD-based prediction scheme makes the points in the lower layer of LOD have greater influence, the lifting wavelet transform-based transform scheme introduces quantization weights, and the prediction residual is updated according to the prediction residual D(N) and the distance between the prediction point and the neighbouring point. Finally, the quantization weights in the transform process are used to adaptively quantize the prediction residual. It should be noted here that the value of the quantization weight of each point may be determined through the geometric reconstruction at the decoding end, and it is not necessary to encode the quantization weight.

### (c) Region Adaptive Hierarchical Transform.

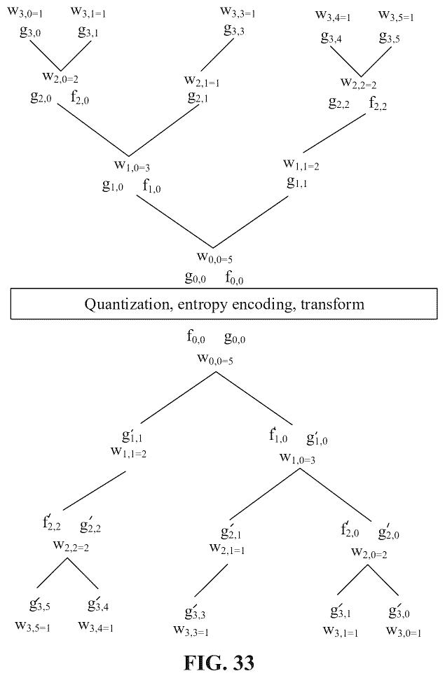

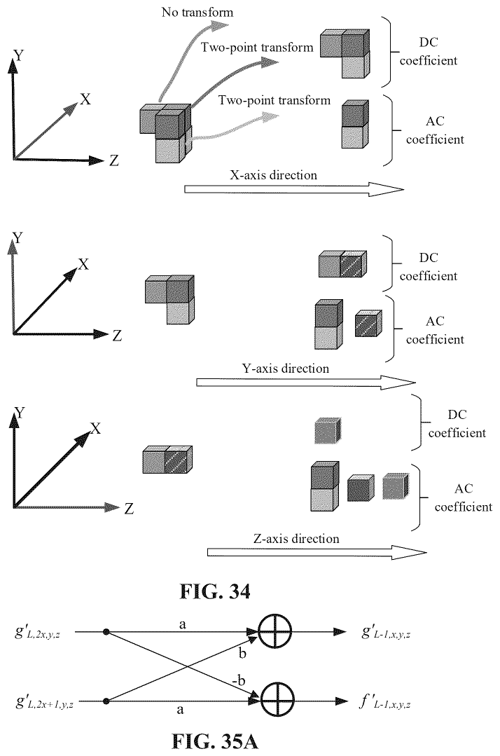

Region adaptive hierarchical transform (RAHT) is a kind of Haar wavelet transform, which can transform the attribute information of the point cloud from spatial domain to frequency domain, and further reduce the correlation between the attributes of the point cloud. The main principle is to transform the nodes of each layer from the three dimensions X, Y, and Z in a bottom-up manner according to the octree structure (as illustrated in FIG. 34), and iterate until the root node of the octree. As illustrated in FIG. 33, the basic principle is that the wavelet transform is performed based on the hierarchical structure of the octree, the attribute information is associated with the octree nodes, the attributes of the occupied nodes of the same parent node are recursively transformed in the bottom-up manner, and the nodes of each layer are transformed from three dimensions X, Y, and Z until the transform reaches the root node of the octree. In the process of hierarchical transform, the low-pass/low-frequency (DC) coefficients obtained after the transform of nodes of the same layer are transferred to the nodes of the next layer for continued transform, and all the high-pass/high-frequency (AC) coefficients may be encoded by the arithmetic encoder.

During the transform process, the transformed DC coefficients (DC components) of the same layer nodes will be transferred to the upper layer for continuous transform, and the transformed AC coefficients (AC components) of each layer will be quantized and encoded. The main transform process will be described below.

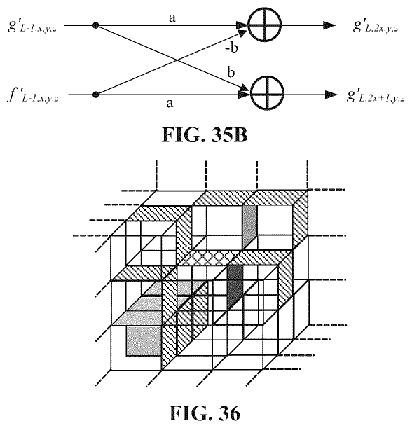

FIG. 35A is a schematic diagram of a process of a RAHT forward transform, and FIG. 35B is a schematic diagram of a process of an RAHT inverse transform. For the transform and inverse transform corresponding to the RAHT, it is assumed that

$${g}_{L , 2 x , y , z}^{′} and {g}_{L , 2 x + 1 , y , z}^{′}$$

are two attribute DC coefficients of two mutually neighboring points of the layer L. After the linear transform, the information of the layer (L−1) is AC coefficient

$${f}_{L - 1 , x , y , z}^{′}$$

and DC coefficient

$${g}_{L - 1 , x , y , z}^{′} .$$

Then, no transform will be performed on

$${f}_{L - 1 , x , y , z}^{′} .$$

Quantization encoding will be performed directly on

$${f}_{L - 1 , x , y , z}^{′} ,$$

and the nearest neighbours will continue to be found for the transform of the

$${g}_{L - 1 , x , y , z}^{′} .$$

If the nearest neighbours cannot be found, it will be directly transferred to the layer (L-2). That is, the RAHT transform is only valid for nodes with neighbouring points, and nodes without neighbouring points will be directly transferred to the upper layer. In the above transform process, the weights (the number of non-empty child nodes in the node) corresponding to

$${g}_{L , 2 x , y , z}^{′} and {g}_{L , 2 x + 2 , y , z}^{′}$$

are respectively

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 , x , y , z}^{′} is {w}_{L - 1 , x , y , z}^{′} ,$$

then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 , x , y , z}^{′} \\ {g}_{L , 2 x + 1 , y , z}^{′}\end{matrix} ] \qquad ( 29 )$$

Here, T_{w0,w1} is the transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 30 )$$

The transform matrix will be updated adaptively with the weights corresponding to the points. The above process will be iteratively updated according to the partition structure of the octree until the root node of the octree.

In a specific implementation, for the region adaptive hierarchical intra prediction transform encoding, prediction may be performed on the basis of the RAHT transform encoding. As illustrated in FIG. 33, the RAHT attribute transform is based on the sequence of the octree levels, and the voxel level is continuously transformed until the root node is obtained, thereby completing the entire hierarchical transform encoding of the attribute. In the predictive transform encoding, the attribute prediction transform encoding is also performed based on the hierarchical order of the octree, but the transform is continuously performed from the root node to the voxel level. In the process of each RAHT attribute transform, the attribute prediction transform encoding is performed based on 2×2×2 blocks, and the specific process is illustrated in FIG. 36. As illustrated in FIG. 36, it may be seen that the block filled with grids is the current block to-be-encoded, and the blocks filled with slashes are some neighbouring blocks that are coplanar and collinear with the current block to-be-encoded. The attributes of the current block are normalized in the following manner:

$${A}_{n o d e} = {\sum }_{p ∈ node} attribute ( p ) ;$$

$${w}_{n o d e} = {\sum }_{p ϵ node} 1 = \{ p ∈ node \} ;$$

$${a}_{n o d e} = {A}_{n o d e} / {w}_{n o d e} .$$

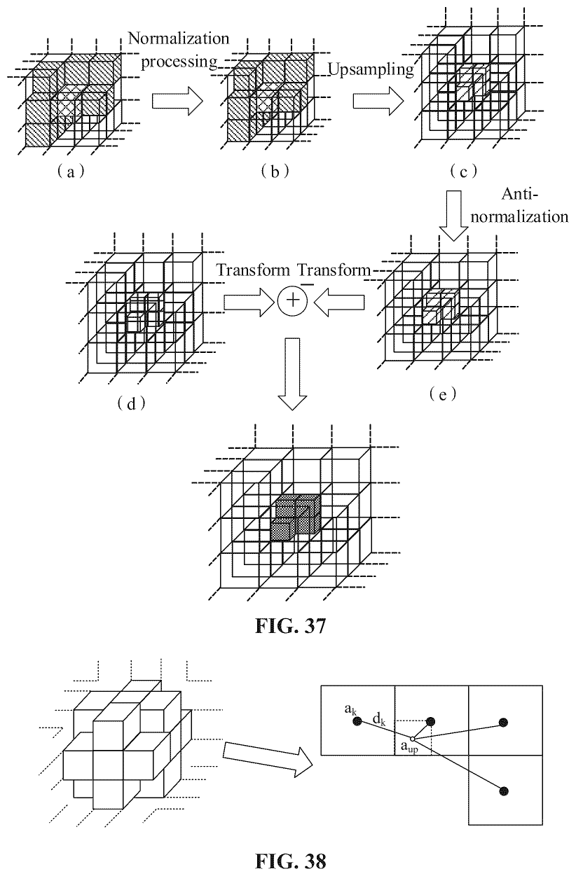

Firstly, the attribute of the current block is obtained through the attributes of the points included in the current block (i.e., A_{node}). The attributes of points included in the current block are simply added, and then the attributes of the current block and the number of points in the current block are normalized to obtain the mean value a_{node} of the attributes of the current block. The mean value of the attributes of the current block is used to perform the attribute transform encoding. The specific encoding process is illustrated in FIG. 37.

As illustrated in FIG. 37, the overall flow of the RAHT attribute prediction transform encoding is illustrated. Here, (a) is the current block and some coplanar and collinear neighbouring blocks, (b) is the normalized block, (c) is the upsampled block, (d) is the attribute of the current block, (e) is the attribute of the prediction block obtained by using the neighbouring attribute of the current block for the linear weighted fitting, and finally the attribute transform is respectively performed on the attribute of the prediction block and neighbouring attribute of the current block to obtain DC and AC coefficients. The prediction encoding is performed on the AC coefficients.

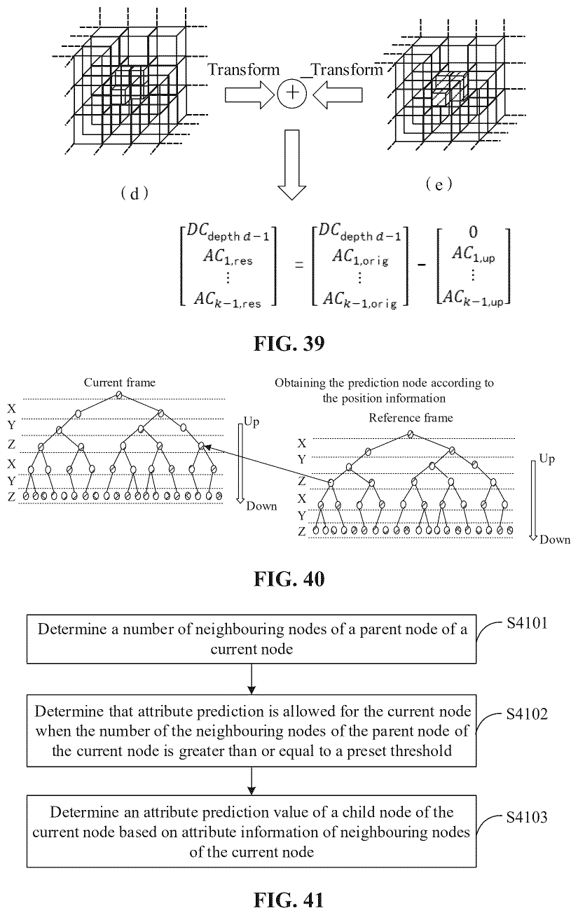

The prediction attribute of the current block may be obtained by performing the linear fitting as illustrated in FIG. 38. As illustrated in FIG. 38, firstly, 19 neighbouring blocks of the current block are obtained. Secondly, the linear weighting prediction is performed on the attribute of each sub-block by using the spatial geometric distance between the neighbouring block and the each sub-block of the current block. Finally, the attribute of the prediction block obtained by linear weighting is transformed. The specific attribute transform is illustrated in FIG. 39.

In FIG. 39, (d) denotes the original attribute value, and the corresponding attribute transform coefficient is as follows:

$$[ \begin{matrix}* \\ {AC}_{1 , orig} \\ ⋮ \\ {AC}_{k - 1 , orig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ] \qquad ( 31 )$$

(e) denotes the attribute prediction value, and the corresponding attribute transform coefficient is as follows:

$$[ \begin{matrix}* \\ {AC}_{1 , up} \\ ⋮ \\ {AC}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ] \qquad ( 32 )$$

The subtraction operation is performed on the original attribute value and the predicted attribute value, and the prediction residual is as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ] \qquad ( 33 )$$

In another specific implementation, for the region adaptive hierarchical inter prediction transform encoding, in the G-PCC attribute inter prediction, the process is similar to that of the intra prediction encoding. Firstly, based on geometric information, the RAHT attribute transform encoding structure is constructed. That is, the voxel level is continuously transformed until the root node is obtained, so that the entire hierarchical transform encoding of the attribute is completed. In this way, an intra encoding structure and an inter attribute encoding structure are constructed. The inter attribute encoding structure is illustrated in FIG. 40.

As illustrated in FIG. 40, firstly, the co-location prediction node of the to-be-encoded node is obtained in the reference frame by using the geometric information of the current node to-be-encoded. Secondly, the prediction attribute of the current node to-be-encoded is obtained by using the geometric information and attribute information of the reference node.

The attribute prediction value of the current node to-be-encoded is obtained according to the following two different manners.

(1) The inter prediction node of the current node is valid. That is, the co-location node exists, and the attribute of the prediction node is directly used as the attribute prediction value of the current node to-be-encoded.

(2) The inter prediction node of the current node is invalid. That is, the co-location node does not exist, and the attribute prediction value of the neighbouring node in the frame is used as the attribute prediction value of the to-be-encoded node.

Finally, the obtained attribute prediction value is used to predict the attribute of the current node to-be-encoded, thereby completing the entire prediction encoding of the attribute.

Simply put, during the RAHT attribute transform encoding of the G-PCC, the encoding and decoding may be performed according to the order from the root node to the child node. Firstly, the geometric information of the current layer node is used to recover the child node of the current layer in the order of Z, Y and X. Secondly, the reconstructed attributes of the parent node layer are used to perform the prediction decoding on the attributes of the current layer node, so that the attributes of the nodes of the current layer can be recovered until the child node is obtained by transform (i.e., voxel level). However, in the G-PCC, when the prediction encoding is performed on the attribute transform coefficients of each node, there will be a starting condition of whether to start prediction coding, as follows:
(1) whether the number of the neighbouring nodes of the current node is greater than the first threshold; and
(2) whether the number of the neighbouring nodes of the parent node corresponding to the current node is greater than the second threshold.

The prediction encoding is performed on the attribute encoding coefficients of the current node if and only if both conditions are met simultaneously. The first threshold and the second threshold may be the same or different. Based on such encoding starting conditions, the entire prediction encoding of the attribute is completed. In this way, it is necessary to store not only the number of neighbouring nodes of the current node, but also the number of neighbouring nodes of the parent node corresponding to the current node, which not only increases the memory occupancy rate of the attribute encoding, but also reduces the attributes encoding efficiency of the point cloud.

Based on this, the embodiments of the present disclosure provide an encoding and decoding method. The number of neighbouring nodes of the parent node of the current node is determined. When the number of neighbouring nodes of the parent node of the current node is greater than or equal to a preset threshold, it is determined that the attribute prediction is allowed for the current node. The attribute prediction value of the child node of the current node is determined based on the attribute information of neighbouring nodes of the current node. In this way, the encoding end can determine the attribute residual value of the child node of the current node according to the attribute prediction value of the child node of the current node, and then transmit the attribute residual value to the decoding end through the bitstream. At the decoding end, the attribute residual value of the child node of the current node may be determined by decoding the bitstream. According to the attribute prediction value and the attribute residual value of the child node of the current node, the reconstructed attribute value of the child node of the current node can be restored.

In this way, when the attribute of each node is predicted, the judgment condition of whether to perform the attribute prediction for each node is optimized, so that the attribute coding efficiency of the point cloud can be improved while ensuring the complexity of the coding of the attribute of the point cloud. In addition, it is not necessary to store the number of neighbouring nodes of each node, and the memory occupied by the point cloud attribute encoding and decoding can be further reduced, thereby improving the encoding and decoding performance of the point cloud.

Hereinafter, the embodiments of the present disclosure will be described in detail below with reference to the accompanying drawings.

In an embodiment of the present disclosure, FIG. 41 illustrates a schematic flowchart of a decoding method according to an embodiment of the present disclosure. As illustrate in FIG. 41, the method includes the following operations.

In operation S4101, a number of neighbouring nodes of a parent node of a current node is determined.

It should be noted that, in the embodiments of the present disclosure, the decoding method is applied to a point cloud decoder (which may be simply referred to as a “decoder”). The decoding method may be a point cloud attribute prediction method, and more specifically, may be an RAHT prediction method for the point cloud attribute. Here, the starting condition of the RAHT prediction decoding of the point cloud attribute is mainly optimized to achieve the purpose of improving the efficiency of the encoding of the attributes of the point cloud.

It should also be noted that in the embodiments of the present disclosure, in the point cloud, the points may be all points in the point cloud or some points in the point cloud, and these points are relatively concentrated in space. Here, the current node is a current point to-be-decoded in the point cloud.

In some embodiments, for the current node, the method may further include the following operation. Upsampling is performed based on geometric information of the current node to determine the child node of the current node.

It should be noted that, in the embodiments of the present disclosure, the geometric information of the current node may be position information of the current node. Specifically, the geometric information may be the three-dimensional coordinate information (x, y, z). That is, the upsampling is performed according to the three-dimensional coordinate information of the current node, so as to determine the occupied child nodes of the current node.

It should also be noted that in the embodiments of the present disclosure, in the current node, the number of child nodes is N. N is a positive integer, and the maximum value of N is 8.

In some embodiments, for the current node, the method may further include the following operation. The neighbouring nodes of the current node are determined based on a spatial position of the current node.

It should be noted that, in the embodiments of the present disclosure, the neighbouring nodes of the current node may include at least one of the following items: neighbouring nodes coplanar with the current node, neighbouring nodes collinear with the current node, or neighbouring nodes concurrent with the current node.

In a specific implementation, the neighbouring nodes of the current node may include neighbouring nodes coplanar with the current node and neighbouring nodes collinear with the current node. Exemplarily, as illustrated in FIG. 36, the block filled with grids may represent the current node, and then the blocks filled with slashes may represent some neighbouring nodes that are coplanar and collinear with the current node.

In some embodiments, for the current node, the method may further include the following operations. The parent node of the current node is determined. The neighbouring nodes of the parent node of the current node are determined based on a spatial position of the parent node of the current node.

It should be noted that, in the embodiments of the present disclosure, the neighbouring nodes of the parent node of the current node may include at least one of the following items: neighbouring nodes coplanar with the parent node of the current node, neighbouring nodes collinear with the parent node of the current node, or neighbouring nodes concurrent with the parent node of the current node.

In a specific implementation, the neighbouring nodes of the parent node of the current node may include neighbouring nodes coplanar with the parent node of the current node and neighbouring nodes collinear with the parent node of the current node.

Further, in some embodiments, the operation of determining the number of the neighbouring nodes of the parent node of the current node may include the following operation. Statistics is performed on the number of the neighbouring nodes of the parent node of the current node to determine the number of the neighbouring nodes of the parent node of the current node.

It can be understood that, in the G-PCC coding framework, RAHT may be used not only for the transform but also for the prediction, resulting in high complexity. Considering the problem of high complexity, in the related art, starting conditions are set for whether the attribute prediction is allowed for the current node, which specifically include the following operations. It is determined whether the number of the neighbouring nodes of the current node is greater than the first threshold, and it is determined whether the number of the neighbouring nodes of the parent node of the current node is greater than the second threshold. However, after a lot of experiments and data analysis, it is found that removing one of the judgment conditions (that is, determining whether the number of the neighbouring nodes of the current node is greater than the first threshold) will not result in high complexity and at the same time exhibits significant technical effects in terms of memory occupancy, encoding and decoding efficiency, and other aspects. In this way, by adaptively modifying the judgment conditions of whether the attribute prediction is enabled for the current node (i.e., removing the judgment condition of whether the number of the neighbouring nodes of the current node is greater than the first threshold), the memory occupancy rate of point cloud attribute encoding and decoding can be reduced while ensuring complexity, and the encoding and decoding efficiency of the point cloud can be improved.

That is, in the embodiments of the present disclosure, at the decoding end, with respect to the starting condition of whether attribute prediction is allowed for the current node, it is no longer necessary to determine whether the number of the neighbouring nodes of the current node is greater than the first threshold, and it is no longer necessary to count the number of the neighbouring nodes of the current node. Here, it is only necessary to count the number of the neighbouring nodes of the parent node of the current node, and then determine whether the attribute prediction is allowed for the current node according to whether the number of the neighbouring nodes of the parent node of the current node is greater than a preset threshold (that is, the aforementioned “second threshold”).

In operation S4102, when the number of the neighbouring nodes of the parent node of the current node is greater than or equal to a preset threshold, it is determined that the attribute prediction is allowed for the current node.

In operation S4103, an attribute prediction value of a child node of the current node is determined based on attribute information of neighbouring nodes of the current node.

It should be noted that, in the embodiments of the present disclosure, the preset threshold, the first threshold or the second threshold described above may be a numerical value set in advance in the decoder, and is used to determine whether the attribute prediction is allowed for the current node.

It should also be noted that, in the embodiments of the present disclosure, if the number of the neighbouring nodes of the parent node of the current node is greater than or equal to the preset threshold, it may be determined that the attribute prediction is allowed for the current node. In this case, the operation of determining the attribute prediction value of the child node of the current node based on the attribute information of the neighbouring nodes of the current node shall continue to be performed. Otherwise, if the number of neighbouring nodes of the parent node of the current node is less than the preset threshold, it can be determined that the attribute prediction is not allowed for the current node (in other words, the attribute prediction cannot be performed on the current node). In this case, the attribute prediction of the current node is directly stopped, and the attribute prediction for the next node may be performed.

In addition, it should be noted that, in the embodiments of the present disclosure, in a case that the number of the neighbouring nodes of the parent node of the current node is equal to the preset threshold, it may be determined that the attribute prediction can be performed for the current node, or it may be determined that the attribute prediction cannot be performed for the current node, which is not limited here. In other words, in some embodiments, when the number of the neighbouring nodes of the parent node of the current node is greater than the preset threshold, it is determined that the attribute prediction is allowed for the current node. Then, the attribute prediction value of the child node of the current node is determined based on the attribute information of the neighbouring nodes of the current node.

In the embodiments of the present disclosure, when the attribute prediction is allowed for the current node, in some embodiments, the operation of determining the attribute prediction value of the child node of the current node based on the attribute information of the neighbouring nodes of the current node may include the following operations.

Geometric distances between the neighbouring nodes of the current node and the child node of the current node are determined.

Linear fitting is performed according to the attribute information of the neighbouring nodes of the current node and the geometric distances between the neighbouring nodes of the current node and the child node of the current node, to determine the attribute prediction value of the child node of the current node.

It should be noted that, in the embodiments of the present disclosure, if the attribute of the current node can be predicted, the reconstructed attributes of the neighbouring nodes of the current node and the respective geometric distance between each neighbouring node and the current node may be used to perform linear fitting to obtain the respective attribute prediction value of each child node of the current node.

It should also be noted that, in the embodiments of the present disclosure, the attribute prediction for the current node may be intra-attribute-based prediction transform or inter-attribute-prediction transform, which is not specifically limited here.

In a specific implementation, taking FIG. 38 as an example, 19 neighbouring nodes of the current node are firstly determined, and then linear weighting prediction is performed on the attribute of each child node by using the spatial geometric distances between the neighbouring nodes and the each child node of the current node. Finally, the respective attribute prediction value of each child node is determined according to the prediction value obtained through linear weighting.

In another specific implementation, taking FIG. 40 as an example, the co-location prediction node of the current node is firstly obtained in a reference frame by using the geometric information of the current node, and then the attribute prediction value of the current node is obtained by using the geometric information and attribute information of the node in the reference frame. The attribute prediction value of the current node is obtained according to the following two different manners.

(1) The inter prediction node of the current node is valid. That is, the co-location node exists, and the attribute of the co-location prediction node is directly taken as the attribute prediction value of the current node.

(2) The inter prediction node of the current node is invalid. That is, the co-location node does not exist, and the attribute prediction value of the neighbouring node in the frame is used as the attribute prediction value of the current node.

Further, in some embodiments, the method may further include determining an reconstructed attribute value of the child node of the current node based on the attribute prediction value of the child node of the current node.

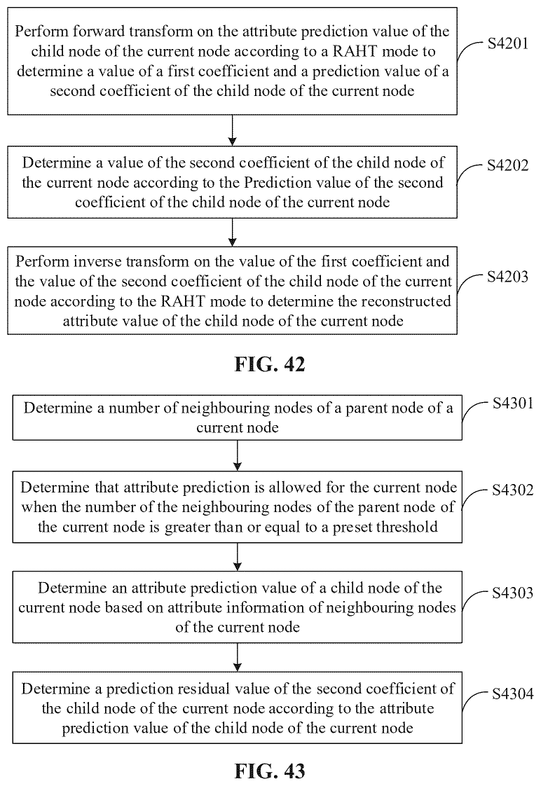

It may be understood that, in the embodiments of the present disclosure, regarding determining the reconstructed attribute value of the child node of the current node, referring to FIG. 42, the method may include the following operations.

In operation S4201, forward transform is performed on the attribute prediction value of the child node of the current node according to the RAHT mode to determine a value of a first coefficient and a prediction value of the second coefficient of the child node of the current node.

It should be noted that, in the embodiments of the present disclosure, the first coefficient may refer to a low-frequency coefficient, or may be referred to as a Direct Current (DC) coefficient. The second coefficient may refer to a high-frequency coefficient, and may also be referred to as an Alternating Current (AC) coefficient. In the process of hierarchical transform, the DC coefficients obtained after the transform of the nodes in the same layer are transferred to the nodes in the next layer to continue the transform, and the AC coefficients after the transform of each layer will be quantized and encoded. Therefore, the value of the second coefficient of the child node of the current node may be determined by decoding the bitstream at the decoding end.

In operation S4202, the value of the second coefficient of the child node of the current node is determined according to the prediction value of the second coefficient of the child node of the current node.

It should also be noted that, in the embodiments of the present disclosure, the AC coefficient prediction value is obtained according to RAHT attribute forward transform, and the AC coefficient of the child node of the current node needs to be recovered by using the AC coefficient prediction value and the AC coefficient residual value that is obtained by parsing the bitstream. In some embodiments, the operation of determining the value of the second coefficient of the child node of the current node according to the prediction value of the second coefficient of the child node of the current node may include the following operations.

A bitstream is decoded to determine the decoded residual value of the second coefficient of the child node of the current node; inverse quantization is performed on the decoded residual value of the second coefficient to obtain the inverse quantization residual value of the second coefficient of the child node of the current node. The value of the second coefficient for the child node of the current node is determined according to the prediction value of the second coefficient and the inverse quantization residual value of the second coefficient.

In a specific embodiment, the operation of determining the value of the second coefficient of the child node of the current node according to the prediction value of the second coefficient and the inverse quantization residual value of the second coefficient may include the operation that an addition operation is performed on the prediction value of the second coefficient and the inverse quantization residual value of the second coefficient to obtain the value of the second coefficient of the child node of the current node.

In the embodiments of the present disclosure, it is assumed that

$${g}_{L , 2 x , y , z}^{′} and {g}_{L , 2 x + 1 , y , z}^{′}$$

are two attribute DC coefficients of two mutually neighboring points of the layer L. After the linear transform, the information of the layer (L−1) is AC coefficient

$${f}_{L - 1 , x , y , z}^{′}$$

and DC coefficient

$${g}_{L - 1 , x , y , z}^{′} .$$

Then, no transform will be performed on

$${f}_{L - 1 , x , y , z}^{′} .$$

Quantization encoding will be performed directly on

$${f}_{L - 1 , x , y , z}^{′} ,$$

and the nearest neighbours will continue to be found for the transform of the

$${g}_{L - 1 , x , y , z}^{′} .$$

If the nearest neighbours cannot be found, it will be directly transferred to the layer (L−2). That is, the RAHT transform is only valid for nodes with neighbouring points, and nodes without neighbouring points will be directly transferred to the upper layer. In the above transform process, the weights (the number of non-empty child node in the node) corresponding to

$${g}_{L , 2 x , y , z}^{′} and {g}_{L , 2 x + 1 , y , z}^{′}$$

are respectivel

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$$of {g}_{L - 1 , x , y , z}^{′} is {w}_{L - 1 , x , y , z}^{′} ,$$

then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 34 )$$

Here, T_{w0,w1} is a transform matrix, and the transform matrix will be updated adaptively with the weights corresponding to the points. The forward transform of the RAHT (which may also be referred to as the “RAHT forward transform”) is illustrated in FIG. 35A described above.

In operation S4203, inverse transform is performed on the value of the first coefficient and the value of the second coefficient of the child node of the current node according to the RAHT mode to determine the reconstructed attribute value of the child node of the current node.

It should be noted that, in the embodiments of the present disclosure, the inverse transform of the RAHT is performed according to the obtained DC coefficient and AC coefficient of the child node of the current node, so that the reconstructed attribute value of the child node of the current node may be recovered. The inverse transform of the RAHT (which may also be referred to as “RAHT inverse transform” or “inverse RAHT transform”) is illustrated in FIG. 35B.

Further, in some embodiments, the method may further include the following operation. When the number of the neighbouring nodes of the parent node of the current node is less than a preset threshold, it is determined that the attribute prediction is not performed on the current node, a next node is taken as the current node, and the operation of determining the number of neighbouring nodes of the parent node of the current node continues to be performed.

It should also be noted that, in the embodiments of the present disclosure, the next node in the point cloud may be sequentially taken as the current node, and the foregoing content may be continuously repeated from the root node of the RAHT transform to the last node of the leaf node layer of the RAHT, thereby completing the decoding of the entire RAHT attribute.

Specifically, in prediction transform decoding, the attribute prediction transform decoding is performed based on the hierarchical order of the octree, and the transform is continuously performed from the root node to the voxel level. Exemplarily, in the process of each RAHT attribute transform, attribute prediction transform decoding is performed based on 2×2×2 blocks.

Further, in some embodiments, the method may further include the following operation. A bitstream is decoded to determine an attribute prediction mode of the current node. When the attribute prediction mode indicates performing attribute decoding on the current node by using a RAHT mode, the operation of determining the number of the neighbouring nodes of the parent node of the current node is performed.

In the embodiments of the present disclosure, the attribute prediction mode may be a prediction transform mode, a lifting transform mode, or a HART mode. In the first two modes, the prediction decoding is performed on the point cloud based on the generation order of the LOD, while in the RAHT mode, the attribute information is adaptively transformed from bottom to top according to the construction level of the octree.

In the embodiments of the present disclosure, at the encoding end, the attribute prediction mode of the current node may be signalled into the bitstream. In this way, the decoder first obtains the attribute prediction mode of the current node through parsing. If the attribute prediction mode indicates that the attribute decoding is performed on the current node by using the RAHT mode, the method of optimizing the starting condition of the RAHT prediction decoding of the attributes may be performed.

Further, in the embodiments of the present disclosure, when the intra prediction mode is used for the current node, in a case that the number of the neighbouring nodes of the parent node of the current node is greater than or equal to the preset threshold, it is determined that the attribute prediction is allowed for the current node, and then the attribute prediction value of the child node of the current node is determined based on the attribute information of the neighbouring nodes of the current node.

Further, in the embodiments of the present disclosure, when the inter prediction mode is used for the current node, in a case that the number of the neighbouring nodes of the parent node of the current node is greater than or equal to the preset threshold, it is determined that the attribute prediction is allowed for the current node, and then the attribute prediction value of the child node of the current node is determined based on the attribute information of the neighbouring nodes of the current node.

Further, in the embodiments of the present disclosure, the starting condition of whether the attribute prediction is allowed for the current node is optimized. Here, it no longer needs to determine whether the data of the neighboring nodes of the parent node of the current node is greater than the preset threshold, but only needs to determine whether the number of the neighboring nodes of the current node is greater than the first threshold.

Further, in the embodiments of the present disclosure, the starting condition of whether the attribute prediction is allowed for the current node is optimized. Here, it no longer needs to determine whether the number of the neighbouring nodes of the current node is greater than the first threshold and whether the number of the neighbouring nodes of the parent node of the current node is greater than the second threshold.

The present embodiment provides a decoding method. The number of the neighbouring nodes of the parent node of the current node is determined. When the number of the neighbouring nodes of the parent node of the current node is greater than or equal to the preset threshold, it is determined that the attribute prediction is allowed for the current node. The attribute prediction value of the child node of the current node is determined based on the attribute information of the neighbouring nodes of the current node. In this way, when performing the attribute prediction on each node, the starting condition of whether the prediction encoding is used for each node is optimized. Specifically, the judgment condition of whether the number of the neighbouring nodes of each node is greater than a certain threshold is removed, and it is only necessary to determine whether the number of the neighbouring nodes of each node is greater than a preset threshold, so that the efficiency of the coding of the attributes of the point cloud can be improved while ensuring the complexity of the coding of the attribute of the point cloud. In addition, it is not necessary to store the number of the neighbouring nodes of each node, and the memory occupied by the point cloud attribute encoding and decoding can be further reduced, thereby improving the encoding and decoding performance of the point cloud.

In an embodiment of the present disclosure, FIG. 43 illustrates a schematic flowchart of an encoding method according to an embodiment of the present disclosure. As illustrated in FIG. 43, the method may include the following operations.

In operation S4301, a number of neighbouring nodes of a parent node of a current node is determined.

It should be noted that, in the embodiments of the present disclosure, the encoding method is applied to a point cloud encoder (which may be simply referred to as an “encoder”). The encoding method may be a point cloud attribute prediction method, more specifically, may be a RAHT prediction method of the attributes of the point cloud. Here, the starting condition of the RAHT prediction encoding of the attributes of the point cloud is mainly optimized to achieve the purpose of improving the efficiency of the encoding of the attributes of the point cloud.

It should also be noted that in the embodiments of the present disclosure, in the point cloud, the points may be all points in the point cloud or some points in the point cloud, and these points are relatively concentrated in space. Here, the current node is the current point to-be-encoded in the point cloud.

In some embodiments, for the current node, the method may further include the following operation. Upsampling is performed based on geometric information of the current node to determine a child node of the current node.

It should be noted that, in the embodiments of the present disclosure, the geometric information of the current node may be position information of the current node. Specifically, the geometric information may be the three-dimensional coordinate information (x, y, z). That is, the upsampling is performed according to the three-dimensional coordinate information of the current node, so as to determine the occupied child nodes of the current node.

It should also be noted that in the embodiments of the present disclosure, in the current node, the number of child nodes is N. N is a positive integer, and the maximum value of N is 8.

In some embodiments, for the current node, the method may further include the following operation. The neighbouring nodes of the current node are determined based on a spatial position of the current node.

It should be noted that, in the embodiments of the present disclosure, the neighbouring nodes of the current node may include at least one of the following items: neighbouring nodes coplanar with the current node, neighbouring nodes collinear with the current node, or neighbouring nodes concurrent with the current node.

In a specific implementation, the neighbouring nodes of the current node may include neighbouring nodes coplanar with the current node and neighbouring nodes collinear with the current node. Exemplarily, as illustrated in FIG. 36, the block filled with grids may represent the current node, and then the blocks filled with slashes may represent some neighbouring nodes that are coplanar and collinear with the current node.

In some embodiments, for the current node, the method may further include the following operations. The parent node of the current node is determined. The neighbouring nodes of the parent node of the current node are determined based on a spatial position of the parent node of the current node.

It should be noted that, in the embodiments of the present disclosure, the neighbouring nodes of the parent node of the current node may include at least one of the following items: neighbouring nodes coplanar with the parent node of the current node, neighbouring nodes collinear with the parent node of the current node, or neighbouring nodes concurrent with the parent node of the current node.

In a specific implementation, the neighbouring nodes of the parent node of the current node may include neighbouring nodes coplanar with the parent node of the current node and neighbouring nodes collinear with the parent node of the current node.

Further, in some embodiments, the operation of determining the number of the neighbouring nodes of the parent node of the current node may include the following operation. Statistics is performed on the number of the neighbouring nodes of the parent node of the current node to determine the number of the neighbouring nodes of the parent node of the current node.

It can be understood that, in the G-PCC coding framework, the RAHT may be used not only for the transform but also for the prediction, resulting in high complexity. Considering the problem of high complexity, in the related art, starting conditions are set for whether the attribute prediction is allowed for the current node, which specifically include the following operations. It is determined whether the number of the neighbouring nodes of the current node is greater than the first threshold, and it is determined whether the number of the neighbouring nodes of the parent node of the current node is greater than the second threshold. However, after a lot of experiments and data analysis, it is found that removing one of the judgment conditions (that is, determining whether the number of the neighbouring nodes of the current node is greater than the first threshold) will not result in high complexity and at the same time exhibits significant technical effects in terms of memory occupancy, encoding and decoding efficiency, and other aspects. In this way, by adaptively modifying the judgment conditions of whether the attribute prediction is enabled for the current node (i.e., removing the judgment condition of whether the number of the neighbouring nodes of the current node is greater than the first threshold), the memory occupancy rate of point cloud attribute encoding and decoding can be reduced while ensuring complexity, and the encoding and decoding efficiency of the point cloud can be improved.

That is, in the embodiments of the present disclosure, at the encoding end, with respect to the starting condition of whether the attribute prediction is allowed for the current node, it is no longer necessary to determine whether the number of the neighbouring nodes of the current node is greater than the first threshold, and it is no longer necessary to count the number of the neighbouring nodes of the current node. Here, it is only necessary to count the number of the neighbouring nodes of the parent node of the current node, and then determine whether the attribute prediction is allowed for the current node according to whether the number of the neighbouring nodes of the parent node of the current node is greater than a preset threshold (that is, the aforementioned “second threshold”).

In operation S4302, when the number of the neighbouring nodes of the parent node of the current node is greater than or equal to a preset threshold, it is determined that attribute prediction is allowed for the current node.

In operation S4303, an attribute prediction value of a child node of the current node is determined based on attribute information of neighbouring nodes of the current node.

It should be noted that, in the embodiments of the present disclosure, the preset threshold, the first threshold or the second threshold described above may be a numerical value set in advance in the decoder, and is used to determine whether the attribute prediction is allowed for the current node.

It should also be noted that, in the embodiments of the present disclosure, if the number of the neighbouring nodes of the parent node of the current node is greater than or equal to the preset threshold, it may be determined that the attribute prediction is allowed for the current node. In this case, the operation of determining the attribute prediction value of the child node of the current node based on the attribute information of the neighbouring nodes of the current node shall continue to be performed. Otherwise, if the number of neighbouring nodes of the parent node of the current node is less than the preset threshold, it can be determined that the attribute prediction is not allowed for the current node (in other words, the attribute prediction cannot be performed on the current node). In this case, the attribute prediction of the current node is directly stopped, and the attribute prediction for the next node may be performed.

In addition, it should be noted that, in the embodiments of the present disclosure, in a case that the number of the neighbouring nodes of the parent node of the current node is equal to the preset threshold, it may be determined that the attribute prediction can be performed for the current node, or it may be determined that the attribute prediction cannot be performed for the current node, which is not limited here. In other words, in some embodiments, when the number of the neighbouring nodes of the parent node of the current node is greater than the preset threshold, it is determined that the attribute prediction is allowed for the current node. Then, the attribute prediction value of the child node of the current node is determined based on the attribute information of the neighbouring nodes of the current node.

In the embodiments of the present disclosure, when the attribute prediction is allowed for the current node, in some embodiments, the operation of determining the attribute prediction value of the child node of the current node based on the attribute information of the neighbouring nodes of the current node may include the following operations.

Geometric distances between the neighbouring nodes of the current node and the child node of the current node are determined.

Linear fitting is performed according to the attribute information of the neighbouring nodes of the current node and the geometric distances between the neighbouring nodes of the current node and the child node of the current node, to determine the attribute prediction value of the child node of the current node.

It should be noted that, in the embodiments of the present disclosure, if the attribute of the current node can be predicted, the reconstructed attributes of the neighbouring nodes of the current node and the respective geometric distance between each neighbouring node and the current node may be used to perform linear fitting to obtain the respective attribute prediction value of each child node of the current node.

It should also be noted that, in the embodiments of the present disclosure, the attribute prediction for the current node may be intra-attribute-based prediction transform or inter-attribute-prediction transform, which is not specifically limited here.

In a specific implementation, taking FIG. 38 as an example, 19 neighbouring nodes of the current node are firstly determined, and then linear weighting prediction is performed on the attribute of each child node by using the spatial geometric distances between the neighbouring nodes and the each child node of the current node. Finally, the respective attribute prediction value of each child node is determined according to the prediction value obtained through linear weighting.

In another specific implementation, taking FIG. 40 as an example, the co-location prediction node of the current node is firstly obtained in a reference frame by using the geometric information of the current node, and then the attribute prediction value of the current node is obtained by using the geometric information and attribute information of the node in the reference frame. The attribute prediction value of the current node is obtained according to the following two different manners.

(1) The inter prediction node of the current node is valid. That is, the co-location node exists, and the attribute of the co-location prediction node is directly taken as the attribute prediction value of the current node.

(2) The inter prediction node of the current node is invalid. That is, the co-location node does not exist, and the attribute prediction value of the neighbouring node in the frame is used as the attribute prediction value of the current node.

In this way, the attribute prediction value of the child node of the current node may be determined according to the attribute information of the neighbouring nodes of the current node.

In operation S4304, a prediction residual value of a second coefficient of the child node of the current node is determined according to the attribute prediction value of the child node of the current node.

It should be noted that, in the embodiments of the present disclosure, the method may further include the following operation. The prediction residual value of the second coefficient of the child node of the current node is encoded to signal obtained encoded bits into a bitstream.

It should also be noted that, in the embodiments of the present disclosure, before encoding the predicted residual value of the second coefficient, it is also necessary to perform quantization on the predicted residual value of the second coefficient. In some embodiments, the method may further include the following operations. Quantization is performed on the prediction residual value of the second coefficient to determine the quantization residual value of the second coefficient of the child node of the current node. The quantization residual value of the second coefficient of the child node of the current node is encoded to signal the obtained encoded bits into the bitstream.

It can be understood that, in some embodiments, the operation of determining the prediction residual value of the second coefficient of the child node of the current node may include the following operations. Forward transform is performed on the attribute prediction value of the child node of the current node according to the RAHT mode to determine a value of a first coefficient and a prediction value of the second coefficient of the child node of the current node. The prediction residual value of the second coefficient of the child node of the current node is determined according to the prediction value of the second coefficient of the child node of the current node.

In the embodiments of the present disclosure, the first coefficient may refer to a low-frequency coefficient, or may be referred to as a DC coefficient. The second coefficient may refer to a high-frequency coefficient, or may be referred to as an AC coefficient. In the process of hierarchical transform, the DC coefficients obtained after the transform of the nodes in the same layer are transferred to the nodes in the next layer to continue the transform, and the AC coefficients after the transform of each layer will be quantized and encoded.

It is also understood that, in some embodiments, the method may further include the following operations. Forward transform is performed on an original attribute value of the child node of the current node according to the RAHT mode to determine the value of the first coefficient and the original value of the second coefficient of the child node of the current node.

In this way, the operation of determining the prediction residual value of the second coefficient of the child node of the current node according to the prediction value of the second coefficient of the child node of the current node may include the operation that the prediction residual value of the second coefficient of the child node of the current node is determined according to the original value of the second coefficient and the prediction value of the second coefficient.

In a specific embodiment, the operation of determining the prediction residual value of the second coefficient of the child node of the current node according to the original value of the second coefficient and the prediction value of the second coefficient may include the operation that a subtraction operation is performed on the original value of the second coefficient and the prediction value of the second coefficient to obtain the prediction residual value of the second coefficient of the child node of the current node.

In the embodiments of the present disclosure, it is assumed that

$${g}_{L , 2 x , y , z}^{′} and {g}_{L , 2 x + 1 , y , z}^{′}$$

are two attribute DC coefficients of two mutually neighboring points of the layer L. After the linear transform the information of the layer (L−1) is AC coefficient

$${f}_{L - 1 , x , y , , z}^{′}$$

and DC coefficient

$${g}_{L - 1 , x , y , z}^{′} .$$

Then, no transform will be performed on

$${f}_{L - 1 , x , y , z}^{′} .$$

Quantization encoding will be performed directly on

$${f}_{L - 1 , x , y , z}^{′} ,$$

and the nearest neighbours will continue to be found for the transform of the

$${g}_{L - 1 , x , y , z}^{′} .$$

If the nearest neighbours cannot be found, it will be directly transferred to the layer (L−2). That is, the RAHT transform is only valid for nodes with neighbouring points, and nodes without neighbouring points will be directly transferred to the upper layer. In the above transform process, the weights (the number of non-empty child nodes in the node) corresponding to

$${g}_{L , 2 x , y , z}^{′} and {g}_{L , 2 x + 2 , y , z}^{′}$$

are respectively

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 , x , y , z}^{′} is {w}_{L - 1 , x , y , z}^{′} ,$$

then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 35 )$$

Here, T_{w0,w1} is a transform matrix, and the transform matrix will be updated adaptively with the weights corresponding to the points. The forward transform of the RAHT is illustrated in FIG. 35A described above.

In the embodiments of the present disclosure, the specific process for calculating the prediction residual value of the AC coefficient of the child node of the current node may be as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ] \qquad ( 36 )$$

Here, DC_{depth d-1} denotes the DC coefficient of the child node of the current node. AC_{1,res} . . . , A_{C}_{_{k-1,res}} denotes the prediction residual value of the AC coefficient of the child node of the current node.

It is also understood that after determining the attribute prediction value of the child node of the current node, the reconstructed attribute value of the child node of the current node may be determined according to the attribute prediction value of the child node of the current node. In some embodiments, the method may further include the following operations.

Inverse quantization is performed on the quantization residual value of the second coefficient of the child node of the current node to obtain the inverse quantization residual value of the second coefficient of the child node of the current node.

The value of the second coefficient of the child node of the current node is determined according to the prediction value of the second coefficient and the inverse quantization residual value of the second coefficient.

Inverse transform is performed on the value of the first coefficient and the value of the second coefficient of the child node of the current node according to the RAHT mode to determine an reconstructed attribute value of the child node of the current node.

It should also be noted that, in the embodiments of the present disclosure, the prediction value of the AC coefficient is obtained according to the RAHT attribute forward transform, and the AC coefficient of the child node of the current node needs to be recovered by using the prediction value of the AC coefficient and the residual value of the AC coefficient after the inverse quantization. Then, the inverse RAHT transform (also referred to as “RAHT inverse transform”) is performed according to the obtained DC coefficient and AC coefficient of the child node of the current node, and the reconstructed attribute value of the child node of the current node may be recovered. The inverse transform of the RAHT is as illustrated in FIG. 35B described above.

Further, in some embodiments, the method may further include the following operation. When the number of the neighbouring nodes of the parent node of the current node is less than a preset threshold, it is determined that the attribute prediction is not performed on the current node, a next node is taken as the current node, and the operation of determining the number of neighbouring nodes of the parent node of the current node continues to be performed.

It should also be noted that, in the embodiments of the present disclosure, the next node in the point cloud may be sequentially taken as the current node, and the foregoing contents may be continuously repeated from the root node of the RAHT transform to the last node of the leaf node layer of the RAHT, thereby completing the encoding of the entire RAHT attribute.

Specifically, in prediction transform encoding, the attribute prediction transform encoding is performed based on the hierarchical order of the octree, and the transform is continuously performed from the root node to the voxel level. Exemplarily, in the process of each RAHT attribute transform, the attribute prediction transform encoding is performed based on 2×2×2 blocks.

Further, in some embodiments, the method may further include the following operations. An attribute prediction mode of the current node is determined. When the attribute prediction mode indicates performing attribute encoding on the current node by using the RAHT mode, the operation of determining the number of the neighbouring nodes of the parent node of the current node is performed.

Further, in some embodiments, the method may further include the following operation. The attribute prediction mode of the current node is encoded to signal obtained encoded bits into a bitstream.

In the embodiments of the present disclosure, the attribute prediction mode may be a prediction transform mode, a lifting transform mode, or the RAHT mode. In the first two modes, the prediction encoding is performed on the point cloud based on the generation order of the LOD, while in the RAHT mode, the attribute information is adaptively transformed from bottom to top according to the construction level of the octree.

In the embodiments of the present disclosure, at the encoding end, the attribute prediction mode of the current node may be signalled into the bitstream. In this way, the decoder first obtains the attribute prediction mode of the current node through parsing. If the attribute prediction mode indicates that the attribute encoding is performed on the current node by using the RAHT mode, the method of optimizing the starting condition of the RAHT prediction encoding of the attributes may be performed.

Further, in the embodiments of the present disclosure, when the intra prediction mode is used for the current node, in a case that the number of the neighbouring nodes of the parent node of the current node is greater than or equal to the preset threshold, it is determined that the attribute prediction is allowed for the current node, and then the attribute prediction value of the child node of the current node is determined based on the attribute information of the neighbouring nodes of the current node.

Further, in the embodiments of the present disclosure, when the inter prediction mode is used for the current node, in a case that the number of the neighbouring nodes of the parent node of the current node is greater than or equal to the preset threshold, it is determined that the attribute prediction is allowed for the current node, and then the attribute prediction value of the child node of the current node is determined based on the attribute information of the neighbouring nodes of the current node.

Further, in the embodiments of the present disclosure, the starting condition of whether the attribute prediction is allowed for the current node is optimized. Here, it no longer needs to determine whether the data of the neighboring nodes of the parent node of the current node is greater than the preset threshold, but only needs to determine whether the number of the neighboring nodes of the current node is greater than the first threshold.

Further, in the embodiments of the present disclosure, the starting condition of whether the attribute prediction is allowed for the current node is optimized. Here, if the complexity is not considered, it no longer needs to determine whether the number of the neighbouring nodes of the current node is greater than the first threshold and whether the number of the neighbouring nodes of the parent node of the current node is greater than the second threshold.

Further, in yet another embodiment of the present disclosure, the embodiments of the present disclosure further provides a bitstream generated by bit encoding according to to-be-encoded information. The to-be-encoded information includes at least one of: an attribute prediction mode of a current node, or the quantization residual value of the second coefficient of the child node of the current node.

In the embodiments of the present disclosure, the attribute prediction mode of the current node is used to indicate whether the attribute encoding is performed on the current node by using the RAHT mode. When the attribute encoding is performed on the current node by using the RAHT mode, the AC coefficient may be determined by adding the prediction value of the AC coefficient obtained by the RAHT forward transform to the quantization residual value of the AC coefficient of the child node of the current node by decoding. Then, the RAHT inverse transform is performed according to the DC coefficient and the AC coefficient, so as to recover the respective reconstructed attribute value of each child node of the current node.

The present embodiment provides an encoding method. The number of the neighbouring nodes of the parent node of the current node is determined. When the number of the neighbouring nodes of the parent node of the current node is greater than or equal to the preset threshold, it is determined that the attribute prediction is allowed for the current node. The attribute prediction value of the child node of the current node is determined based on the attribute information of the neighbouring nodes of the current node. In this way, when performing the attribute prediction on each node, the starting condition of whether the prediction encoding is used for each node is optimized. Specifically, the judgment condition of whether the number of the neighbouring nodes of each node is greater than a certain threshold is removed, and it is only necessary to determine whether the number of the neighbouring nodes of each node is greater than a preset threshold, so that the efficiency of the coding of the attribute of the point cloud can be improved while ensuring the complexity of the coding of the attribute of the point cloud. In addition, it is not necessary to store the number of the neighbouring nodes of each node, and the memory occupied by the point cloud attribute encoding and decoding can be further reduced, thereby improving the encoding and decoding performance of the point cloud.

In another embodiment of the present disclosure, based on the encoding and decoding method of the foregoing embodiments, with respect to the starting conditions of the prediction encoding in the related art, the efficiency of the encoding of the attributes of the point cloud may be further improved by modifying the condition of whether the prediction encoding is started for each node to a certain extent.

In the embodiments of the present disclosure, based on the RAHT prediction encoding of the attributes, the starting condition of the RAHT prediction encoding of the attribute is optimized, so that the efficiency of the encoding of the attributes of the point cloud can be improved without affecting the coding complexity, and the memory occupied by the attribute encoding can be reduced.

In a specific embodiment, at the decoding end, the implementation operations are as follows.

In the first operation, the geometric information of the current node is used for upsampling to obtain the occupied child nodes of the current node (the number of child nodes is N, and the maximum value of N is 8).

In the second operation, neighbouring nodes coplanar and collinear with the current node are determined by using the spatial position of the current node.

In the third operation, if the number M of the neighbouring nodes of the parent node of the current node is greater than or equal to the preset threshold, it is considered that the prediction can be performed on the current node. Otherwise, the attribute of the current node cannot be predicted.

In the fourth operation, if the attribute of the current node can be predicted, the linear fitting is performed by using the reconstructed attributes of the neighbouring nodes of the current node and the spatial geometric distance between each neighbouring node and the current node to obtain the attribute prediction value of the each child node of the current node.

In the fifth operation, the RAHT transform is performed by using the attribute prediction value of each child node to obtain a corresponding DC coefficient and AC coefficient. Finally, the AC coefficient of the prediction node and the AC coefficient obtained by parsing the bitstream are used to recover the AC coefficient of the current node.

In the sixth operation, the RAHT inverse transform is performed by using the AC coefficient and the DC coefficient of the current node, so as to recover the reconstructed attribute value of each child node of the current node.

In the seventh operation, the first to sixth operations are sequentially repeated from the root node of the RAHT transform to the last node of the leaf node layer of the RAHT, thereby completing the decoding of the entire RAHT attribute.

In a specific embodiment, at the encoding end, the implementation operations are as follows.

In the first operation, the upsampling is performed by using the geometric information of the current node to obtain the occupied child nodes of the current node (the number of child nodes is N, and the maximum value of N is 8).

In the second operation, neighbouring nodes coplanar and collinear with the current node are determined by using the spatial position of the current node.

In the third operation, if the number M of the neighbouring nodes of the parent node of the current node is greater than or equal to the preset threshold, it is determined that the prediction can be performed on the current node. Otherwise, the attribute of the current node cannot be predicted.

In the fourth operation, if the attribute of the current node can be predicted, the linear fitting is performed by using the reconstructed attributes of the neighbouring nodes of the current node and the spatial geometric distance between each neighbouring node and the current node to obtain the attribute prediction value of the each child node of the current node.

In the fifth operation, the RAHT transform is performed by using the attribute prediction value of each child node to obtain a corresponding DC coefficient and AC coefficient. Similarly, the attribute of each child node of the current node is transformed by the RAHT transform to obtain the DC coefficient and the AC coefficient.

In the sixth operation, the AC of the current node is predicted by using the prediction value of the AC coefficient obtained through the prediction on the node. Finally, the quantization encoding is performed on the AC prediction residual coefficient of each child node.

In the seventh operation, the AC reconstruction coefficient of the current node is obtained by using the inverse quantization value of the AC prediction residual coefficient and the prediction value of the AC coefficient. Finally, the RAHT inverse transform is performed by using the AC coefficient and the DC coefficient of the current node, thereby recovering the reconstructed attribute value of each child node of the current node.

In the eighth operation, the first to seventh operations are sequentially repeated from the root node of the RAHT transform to the last node of the leaf node layer of the RAHT, thereby completing the encoding of the entire RAHT attribute.

Simply put, in the embodiments of the present disclosure, when encoding the attribute information, the starting condition of the RAHT prediction encoding of the attributes is optimized, so that the efficiency of the encoding of the attributes of the point cloud can be improved without affecting the encoding complexity. Because there is no need to store the number of neighbouring nodes of each node, the memory occupancy of the encoding of the attributes can be further reduced.

Exemplarily, Table 2 shows the test performance results corresponding to the lossless geometry and lossy attributes under the C1_ai test condition. Table 3 shows the test performance results corresponding to the lossy geometry and lossy attributes under the C2_ai test condition. According to Table 2 and Table 3, it may be seen that the efficiency of the encoding of the attributes of the point cloud can be improved, and the encoding and decoding performance of point cloud can be improved.

TABLE 2

| | lossless geometry, lossy attributes [all intra] | | | |
|---|---|---|---|---|
| | End-to-End BD-AttrRate [%] | | | |
| | | Chroma | Chroma | |
| C1_ai | Luma | Cb | Cr | Reflectance |
| Solid average | #DIV/0! | #DIV/0! | #DIV/0! | |
| Dense average | #DIV/0! | #DIV/0! | #DIV/0! | |
| Sparse average | #DIV/0! | #DIV/0! | #DIV/0! | |
| Scant average | #DIV/0! | #DIV/0! | #DIV/0! | |
| Am-fused average | #DIV/0! | #DIV/0! | #DIV/0! | #DIV/0! |
| Am-frame spinning average | | | | −1.9% |
| Am-frame non-spinning | | | | −0.1% |
| average | | | | |
| Overall average | #DIV/0! | #DIV/0! | #DIV/0! | −1.4% |

| | |
|---|---|
| Avg. Enc Time [%] | #NUM! |
| Avg. Dec Time [%] | #NUM! |

TABLE 3

| | lossy geometry, lossy attributes [all intra] | | | | | |
|---|---|---|---|---|---|---|
| | End-to-End BD-AttrRate [%] | | | | Geom. BD-TotGeomRate [%] | |
| C2_ai | Luma | Chroma Cb | Chroma Cr | Reflectance | D1 | D2 |
| Solid average | #DIV/0! | #DIV/0! | #DIV/0! | | #DIV/0! | #DIV/0! |
| Dense average | #DIV/0! | #DIV/0! | #DIV/0! | | #DIV/0! | #DIV/0! |
| Sparse average | #DIV/0! | #DIV/0! | #DIV/0! | | #DIV/0! | #DIV/0! |
| Scant average | #DIV/0! | #DIV/0! | #DIV/0! | | #DIV/0! | #DIV/0! |
| Am-fused average | #DIV/0! | #DIV/0! | #DIV/0! | #DIV/0! | #DIV/0! | #DIV/0! |
| Am-frame spinning average | | | | −2.3% | 0.0% | 0.0% |
| Am-frame non-spinning average | | | | −0.3% | 0.0% | |
| Overall average | #DIV/0! | #DIV/0! | #DIV/0! | −1.7% | 0.0% | 0.0% |

In the embodiments of the present disclosure, the specific implementation of the aforementioned embodiments is described in detail through the aforementioned embodiments. It can be seen that according to the technical solutions of the aforementioned embodiments, when performing the RAHT encoding on the attribute, by optimizing the starting conditions of whether the prediction encoding is used for each node (i.e., by removing the condition that it is necessary to determine whether the number of the neighbouring nodes of the current node is greater than a certain threshold when predicting the attribute of each node), the efficiency of the encoding of the attributes of the point cloud can be improved while ensuring the complexity of encoding the attribute of the point cloud, thereby improving encoding and decoding performance. In addition, it is not necessary to store the number of the neighbouring nodes of each node, and the memory occupied by the point cloud attribute encoding and decoding can be further reduced, thereby improving the encoding and decoding performance of the point cloud.

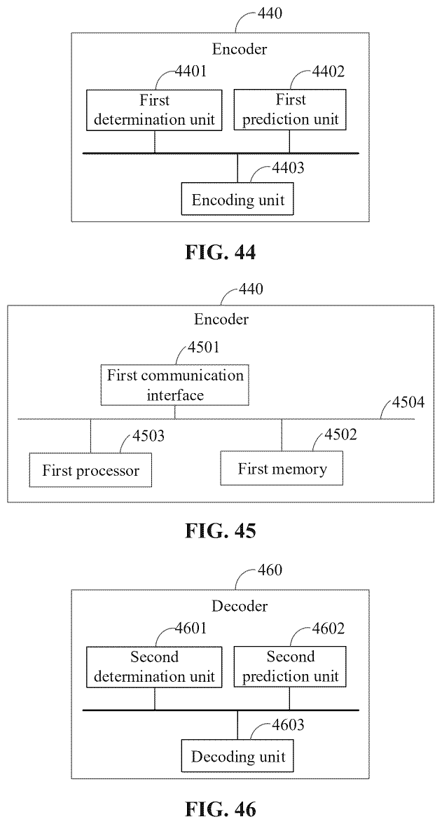

In still another embodiment of the present disclosure, based on the same inventive concept as the above-described embodiments, FIG. 44 illustrates a structural composition of an encoder according to an embodiment of the present disclosure. As illustrated in FIG. 44, the encoder 440 includes a first determination unit 4401 and a first prediction unit 4402.

The first determination unit 4401 is configured to determine a number of neighbouring nodes of a parent node of a current node; and determine that attribute prediction is allowed for the current node when the number of the neighbouring nodes of the parent node of the current node is greater than or equal to a preset threshold.

The first prediction unit 4402 is configured to determine an attribute prediction value of a child node of the current node based on attribute information of neighbouring nodes of the current node.

In some embodiments, the first determination unit 4401 is further configured to perform upsampling based on geometric information of the current node to determine a child node of the current node.

In some embodiments, the first determination unit 4401 is further configured to determine neighbouring nodes of the current node based on a spatial position of the current node. The neighbouring nodes of the current node at least include neighbouring nodes coplanar with the current node and neighbouring nodes collinear with the current node.

In some embodiments, the first determination unit 4401 is further configured to determine the parent node of the current node; and determine the neighbouring nodes of the parent node of the current node based on a spatial position of the parent node of the current node. The neighbouring nodes of the parent node of the current node at least include neighbouring nodes coplanar with the parent node of the current node and neighbouring nodes collinear with the parent node of the current node.

In some embodiments, the first determination unit 4401 is further configured to perform statistics on the number of the neighbouring nodes of the parent node of the current node to determine the number of the neighbouring nodes of the parent node of the current node.

In some embodiments, the first prediction unit 4402 is further configured to determine geometric distances between the neighbouring nodes of the current node and the child node of the current node; and performing linear fitting according to the attribute information of the neighbouring nodes of the current node and the geometric distances between the neighbouring nodes of the current node and the child node of the current node, to determine the attribute prediction value of the child node of the current node.

In some embodiments, referring to FIG. 44, the encoder 440 may further include an encoding unit 4403.

The first determination unit 4401 is further configured to determine a prediction residual value of a second coefficient of the child node of the current node according to the attribute prediction value of the child node of the current node; and perform quantization processing on the prediction residual value of the second coefficient to determine the quantization residual value of the second coefficient of the child node of the current node.

The encoding unit 4403 is configured to encode the quantization residual value of the second coefficient of the child node of the current node, and signal obtained encoded bits into a bitstream.

In some embodiments, the first determination unit 4401 is further configured to perform forward transform on the attribute prediction value of the child node of the current node according to a region adaptive hierarchical transform (RAHT) mode to determine a value of a first coefficient and a prediction value of the second coefficient of the child node of the current node, and determine the prediction residual value of the second coefficient of the child node of the current node according to the prediction value of the second coefficient of the child node of the current node.

In some embodiments, the first determination unit 4401 is further configured to perform forward transform on an original attribute value of the child node of the current node according to the RAHT mode to determine the value of the first coefficient and an original value of the second coefficient of the child node of the current node; and determine the prediction residual value of the second coefficient of the child node of the current node according to the original value of the second coefficient and the prediction value of the second coefficient.

In some embodiments, the first determination unit 4401 is further configured to perform a subtraction operation on the original value of the second coefficient and the prediction value of the second coefficient to obtain the prediction residual value of the second coefficient of the child node of the current node.

In some embodiments, the first determination unit 4401 is further configured to: perform inverse quantization on the quantization residual value of the second coefficient of the child node of the current node to obtain the inverse quantization residual value of the second coefficient of the child node of the current node; determine the value of the second coefficient of the child node of the current node according to the prediction value of the second coefficient and the inverse quantization residual value of the second coefficient; and perform inverse transform on the value of the first coefficient and the value of the second coefficient of the child node of the current node according to the RAHT mode to determine an reconstructed attribute value of the child node of the current node.

In some embodiments, the first determination unit 4401 is further configured to: when the number of the neighbouring nodes of the parent node of the current node is less than the preset threshold, determine that the attribute prediction is not performed on the current node, take a next node as the current node, and continue performing the operation of determining the number of the neighbouring nodes of the parent node of the current node.

In some embodiments, the first determination unit 4401 is further configured to: determine an attribute prediction mode for the current node; and when the attribute prediction mode indicates performing the attribute encoding on the current node by using the RAHT mode, perform the operation of determining the number of the neighbouring nodes of the parent node of the current node.

In some embodiments, the encoding unit 4403 is further configured to perform encoding processing on the attribute prediction mode of the current node to signal the obtained encoded bits into a bitstream.

It can be understood that in the embodiments of the present disclosure, a “unit” may be a part of a circuit, a part of a processor, a part of programs or software, etc. Of course the “unit” may also be a module, or may be non-modular. Moreover, the various components in the embodiments of the present disclosure may be integrated in one processing unit, or each unit may exist physically alone, or two or more units may be integrated in one unit. The integrated unit may be implemented either in the form of hardware or in the form of software function module.

If the integrated unit is implemented in the form of software functional modules and sold or used as an independent product, it may also be stored in a computer-readable storage medium. Based on such understanding, technical solutions of the embodiments of the present disclosure substantially or parts making contributions to the related art may be embodied in the form of software. The computer software product is stored in a storage medium, includes several instructions to cause a computer device (which may be a personal computer, a server, a network device, etc.) or a processor to perform all or part of the operations of the method according to the embodiments of the present disclosure. The above storage media include: a U disk, a removable hard disk, a Read-Only Memory (ROM), a Random Access Memory (RAM), a disk or an optical disk and other media that can store program codes.

Accordingly, embodiments of the present disclosure provide a computer-readable storage medium applied to the encoder 440. The computer-readable storage medium stores a computer program that implements the method of any one of the foregoing embodiments when executed by the first processor.

Based on the composition of the encoder 440 and the computer-readable storage medium described above, FIG. 45 illustrates a schematic diagram of a specific hardware structure of the encoder 440 according to an embodiment of the present disclosure. As illustrated in FIG. 45, the encoder 440 may include a first communication interface 4501, a first memory 4502, and a first processor 4503. The various components are coupled together by the first bus system 4504. It will be appreciated that the first bus system 4504 is used to enable connected communication between these components. The first bus system 4504 may include a power bus, a control bus, and a status signal bus in addition to a data bus. For clarity of illustration, however, various buses are designated as the first bus system 4504 in FIG. 45.

The first communication interface 4501 is configured to receive and send signals in the process of sending and receiving information with other external network elements.

The first memory 4502 is configured to store a computer program executable on the first processor 4503.

The first processor 4503 is configured, when running the computer program, to perform the following operations.

A number of neighbouring nodes of a parent node of a current node is determined.

When the number of the neighbouring nodes of the parent node of the current node is greater than or equal to a preset threshold, it is determined that attribute prediction is allowed for the current node.

An attribute prediction value of a child node of the current node is determined based on attribute information of neighbouring nodes of the current node.

It can be understood that the first memory 4502 in the embodiments of the present disclosure may be a volatile memory or a non-volatile memory, or may include both the volatile memory and the non-volatile memory. The non-volatile memory may be an ROM, a Programmable ROM (PROM), an Erasable PROM (EPROM), an Electrically EPROM (EEPROM) or a flash memory. The volatile memory may be a Random Access Memory (RAM) and is used as an external high-speed cache. It is exemplarily but unlimitedly described that RAMs in various forms may be adopted, such as a static RAM (SRAM), a dynamic RAM (DRAM), a Synchronous DDRAM (SDRAM), a double data rate SDRAM (DDR SDRAM), an Enhanced SDRAM (ESDRAM), a Synchlink DRAM (SLDRAM) and a Direct Rambus RAM (DR RAM). It should be noted that the memory 4502 of the system and methods described herein is intended to include, but not be limited to, memories of these and any other suitable types.

The first processor 4503 may be an integrated circuit chip with signal processing capacity. In the implementation process, various operations of the above methods may be completed by integrated logic circuits of hardware in the first processor 4503 or instructions in the form of software. The above first processor 4503 may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software modules may be located in a mature storage medium in the art, such as a random access memory, a flash memory, a read-only memory, a programmable read-only memory or electrically erasable programmable memory, or a register. The storage medium is located in the first memory 4502, and the first processor 4503 reads information in the first memory 4502 and completes the steps in the foregoing methods in combination with hardware of the processor.

It can be understood that the embodiments described herein may be implemented in hardware, software, firmware, middleware, microcode or a combination thereof. For the hardware implementation, the processing unit may be implemented in one or more Application Specific Integrated Circuits (ASICs), Digital Signal Processors (DSPDs), Digital Signal Processing Devices (DSPDs), Programmable Logic Devices (PLDs), Field-Programmable Gate Arrays (FPGAs), general purpose processors, controllers, microcontrollers, microprocessors, other electronic units or combinations thereof for performing the functions described herein. For software implementations, the technology described herein may be implemented by modules (e.g. procedures, functions, etc.) that perform the functions described herein. The software codes may be stored in memory and executed by a processor. The memory can be implemented in the processor or outside the processor.

Optionally, as another embodiment, the first processor 4503 is further configured to perform the method described in any one of the aforementioned embodiments when running the computer program.

The embodiment provides an encoder. When the RAHT transform is performed by the encoder on the attribute, the starting condition of whether the prediction coding is performed for each node is optimized, so that the efficiency of the coding of the attributes of the point cloud can be improved while ensuring the complexity of the coding of the attributes of the point cloud. In addition, it is not necessary to store the number of the neighbouring nodes of each node, and the memory occupied by the point cloud attribute encoding and decoding can be further reduced, thereby improving the encoding and decoding performance of the point cloud.

In still another embodiment of the present disclosure, based on the same inventive concept as the above-described embodiments, FIG. 46 illustrates a schematic diagram of a structural composition of a decoder according to an embodiment of the present disclosure. As illustrated in FIG. 46, the decoder 460 includes a second determination unit 4601 and a second prediction unit 4602.

The second determination unit 4601 is configured to: determine a number of neighbouring nodes of a parent node of a current node; and determine that attribute prediction is allowed for the current node when the number of the neighbouring nodes of the parent node of the current node is greater than or equal to a preset threshold.

The second prediction unit 4602 is configured to determine an attribute prediction value of a child node of the current node based on attribute information of neighbouring nodes of the current node.

In some embodiments, the second determination unit 4601 is further configured to perform upsampling based on geometric information of the current node to determine the child node of the current node.

In some embodiments, the second determination unit 4601 is further configured to determine the neighbouring nodes of the current node based on a spatial position of the current node. The neighbouring nodes of the current node at least include neighbouring nodes coplanar with the current node and neighbouring nodes collinear with the current node.

In some embodiments, the second determination unit 4601 is further configured to: determine the parent node of the current node; and determine the neighbouring nodes of the parent node of the current node based on a spatial position of the parent node of the current node. The neighbouring nodes of the parent node of the current node at least include neighbouring nodes coplanar with the parent node of the current node and neighbouring nodes collinear with the parent node of the current node.

In some embodiments, the second determination unit 4601 is further configured to: perform statistics on the number of the neighbouring nodes of the parent node of the current node to determine the number of the neighbouring nodes of the parent node of the current node.

In some embodiments, the second prediction unit 4602 is further configured to: determine geometric distances between the neighbouring nodes of the current node and the child node of the current node; and perform linear fitting according to the attribute information of the neighbouring nodes of the current node and the geometric distances between the neighbouring nodes of the current node and the child node of the current node, to determine the attribute prediction value of the child node of the current node.

In some embodiments, the second determination unit 4601 is further configured to determine an reconstructed attribute value of the child node of the current node based on the attribute prediction value of the child node of the current node.

In some embodiments, the second determination unit 4601 is further configured to: perform forward transform on the attribute prediction value of the child node of the current node according to a region adaptive hierarchical transform (RAHT) mode to determine a value of a first coefficient and a prediction value of the second coefficient of the child node of the current node; determine the value of the second coefficient of the child node of the current node according to the prediction value of the second coefficient of the child node of the current node; and perform inverse transform on the value of a first coefficient and the value of the second coefficient of the child node of the current node according to the RAHT mode to determine the reconstructed attribute value of the child node of the current node.

In some embodiments, referring to FIG. 46, the decoder 460 may further include a decoding unit 4603. The decoding unit 4603 is configured to decode a bitstream to determine the decoded residual value of the second coefficient of the child node of the current node.

The second determination unit 4601 is further configured to: perform inverse quantization on the decoded residual value of the second coefficient to obtain the inverse quantization residual value of the second coefficient of the child node of the current node; and determine the value of the second coefficient for the child node of the current node according to the prediction value of the second coefficient and the inverse quantization residual value of the second coefficient.

In some embodiments, the second determination unit 4601 is further configured to perform an addition operation based on the prediction value of the second coefficient and the inverse quantization residual value of the second coefficient to obtain the value of the second coefficient of the child node of the current node.

In some embodiments, the second determination unit 4601 is further configured to: determine that the attribute prediction is not performed on the current node, take a next node as the current node, and continue performing the operation of determining the number of the neighbouring nodes of the parent node of the current node.

In some embodiments, the decoding unit 4603 is further configured to decode a bitstream to determine an attribute prediction mode of the current node.

The second determination unit 4601 is further configured to perform the operation of determining the number of the neighbouring nodes of the parent node of the current node when the attribute prediction mode indicates performing the attribute decoding on the current node by using a region adaptive hierarchical transform (RAHT) mode.

It can be understood that in the embodiments of the present disclosure, a “unit” may be a part of a circuit, a part of a processor, a part of programs or software, etc. Of course the “unit” may also be a module, or may be non-modular. Moreover, the various components in the embodiments of the present disclosure may be integrated in one processing unit, or each unit may exist physically alone, or two or more units may be integrated in one unit. The integrated unit may be implemented either in the form of hardware or in the form of software function module.

If the integrated unit is implemented in the form of software functional modules and sold or used as an independent product, it can be stored in a computer readable storage medium. Based on such understanding, the present embodiment provides a computer-readable storage medium applied to the decoder 460, and the computer-readable storage medium having stored thereon a computer program that, when executed by a second processor, causes the second processor to implement the method described in any one of the preceding embodiments.

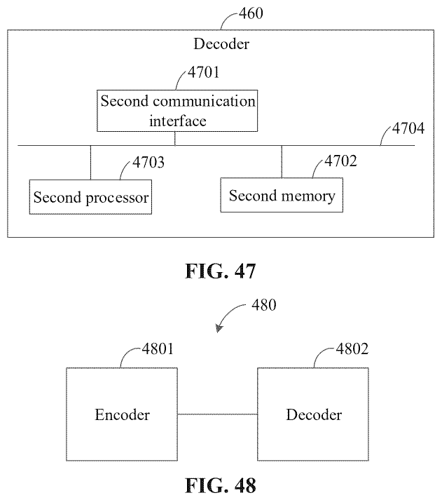

Based on the composition of the decoder 460 and the computer-readable storage medium described above, with reference to FIG. 47, a schematic diagram of a specific hardware structure of a decoder 460 according to an embodiment of the present disclosure is illustrated. As illustrated in FIG. 47, the decoder 460 may include a second communication interface 4701, a second memory 4702 and a second processor 4703. The components are coupled together by a second bus system 4704. It can be understood that the second bus system 4704 is configured to implement connection communication between these components. The second bus system 4704 includes a power bus, a control bus and a status signal bus in addition to a data bus. However, for the sake of clarity, the various buses are designated in FIG. 47 as the second bus system 4704.

The second communication interface 4701 is configured to receive and send signal in the process of sending and receiving information with other external network elements.

The second memory 4702 is configured to store computer programs that can be run on the second processor 4703.

The second processor 4703 is configured to, when running the computer programs, run the computer programs to perform the following three operations.

A number of neighbouring nodes of a parent node of a current node is determined.

When the number of the neighbouring nodes of the parent node of the current node is greater than or equal to a preset threshold, it is determined that attribute prediction is allowed for the current node.

An attribute prediction value of a child node of the current node is determined based on attribute information of neighbouring nodes of the current node.

Alternatively, as another embodiment, the second processor 4703 is further configured to perform the method of any one of the preceding embodiments when running the computer programs.

It can be understood that the hardware function of the second memory 4702 is similar to that of the first memory 4502, and the hardware function of the second processor 4703 is similar to that of the first processor 4503, which will not be detailed here.

The present embodiment provides a decoder. When the RAHT transform is performed by the decoder on the attribute, the starting condition of whether the prediction coding is performed for each node is optimized, so that the efficiency of the coding of the attributes of the point cloud can be improved while ensuring the complexity of the coding of the attributes of the point cloud. In addition, it is not necessary to store the number of the neighbouring nodes of each node, and the memory occupied by the point cloud attribute encoding and decoding can be further reduced, thereby improving the encoding and decoding performance of the point cloud.

In another embodiment of the present disclosure, with reference to FIG. 48, a schematic diagram of a structural composition of an encoding and decoding system according to an embodiment of the present disclosure is illustrated. As illustrated in FIG. 48, the encoding and decoding system 480 may include an encoder 4801 and a decoder 4802.

In the embodiments of the present disclosure, the encoder 4801 may be the encoder described in any one of the aforementioned embodiments, and the decoder 4802 may be the decoder described in any one of the aforementioned embodiments.

It should be noted that, in this disclosure, the terms “include”, “comprise” or any other variation thereof, are intended to cover a non-exclusive inclusion, such that a process, method, article, or device that includes a list of elements includes not only those elements but also other elements not expressly listed, or also includes elements inherent to such process, method, article, or device. Without further restrictions, an element defined by the phrase “including one . . . ” does not preclude the presence of additional identical elements in the process, method, article, or apparatus that includes the element.

The serial numbers of the above-described embodiments of the present disclosure are merely for descriptive purposes and do not represent the superiority or inferiority of the embodiments.

The methods disclosed in several method embodiments provided in the present disclosure can be arbitrarily combined without conflict to obtain new method embodiments.

The features disclosed in several product embodiments provided in the present disclosure can be arbitrarily combined without conflict to obtain new product embodiments.

The features disclosed in several methods or device embodiments provided in the present disclosure can be arbitrarily combined without conflict to obtain new method embodiments or device embodiments.

Embodiments of the present disclosure provide an encoding and decoding method, a bitstream, an encoder, a decoder, and a storage medium, which can improve the attributes coding efficiency of the point cloud and reduce memory occupancy of attribute coding, thereby improving encoding and decoding performance of the point cloud.

The technical solutions of the embodiments of the present disclosure may be realized as follows.

In a first aspect, the embodiments of the present disclosure provide a decoding method. The method is applied to a decoder and includes the following operations.

A number of neighbouring nodes of a parent node of a current node is determined.

When the number of the neighbouring nodes of the parent node of the current node is greater than or equal to a preset threshold, it is determined that attribute prediction is allowed for the current node.

An attribute prediction value of a child node of the current node is determined based on attribute information of neighbouring nodes of the current node.

In a second aspect, the embodiments of the present disclosure provide an encoding method. The method is applied to an encoder and includes the following operations.

A number of neighbouring nodes of a parent node of a current node is determined.

When the number of the neighbouring nodes of the parent node of the current node is greater than or equal to a preset threshold, it is determined that attribute prediction is allowed for the current node.

An attribute prediction value of a child node of the current node is determined based on attribute information of neighbouring nodes of the current node.

In a third aspect, the embodiments of the present disclosure provide a bitstream. The bitstream is generated by performing bit encoding according to to-be-encoded information.

The to-be-encoded information includes at least one of: an attribute prediction mode of a current node, or a quantization residual value of a second coefficient of a child node of the current node.

In a fourth aspect, the embodiments of the present disclosure provide an encoder. The encoder includes a first determination unit and a first prediction unit.

The first determination unit is configured to determine a number of neighbouring nodes of a parent node of a current node; and determine that attribute prediction is allowed for the current node when the number of the neighbouring nodes of the parent node of the current node is greater than or equal to a preset threshold.

The first prediction unit is configured to determine an attribute prediction value of a child node of the current node based on attribute information of neighbouring nodes of the current node.

In a fifth aspect, the embodiments of the present disclosure provide an encoder. The encoder includes a first memory and a first processor.

The first memory is configured to store a computer program executable on the first processor.

The first processor is configured to perform the method of the second aspect when executing the computer program.

In a sixth aspect, the embodiments of the present disclosure provide a decoder. The decoder includes a second determination unit and a second prediction unit.

The second determination unit is configured to determine a number of neighbouring nodes of a parent node of a current node; and determine that attribute prediction is allowed for the current node when the number of the neighbouring nodes of the parent node of the current node is greater than or equal to a preset threshold.

The second prediction unit is configured to determine an attribute prediction value of a child node of the current node based on attribute information of neighbouring nodes of the current node.

In a seventh aspect, the embodiments of the present disclosure provide a decoder. The decoder includes a second memory and a second processor.

The second memory is configured to store a computer program executable on the second processor.

The second processor is configured to perform the method according to the first aspect when executing the computer program.

In an eighth aspect, the embodiments of the present disclosure provide a computer-readable storage medium. The computer-readable storage medium is configured to store a computer program that, when executed, implements the method according to the first aspect or implements the method according to the second aspect.

The embodiments of the present disclosure provide an encoding and decoding method, a bitstream, an encoder, a decoder, and a storage medium. Whether at the encoding end or the decoding end, a number of neighbouring nodes of a parent node of a current node is determined. When the number of the neighbouring nodes of the parent node of the current node is greater than or equal to a preset threshold, it is determined that attribute prediction is allowed for the current node, and an attribute prediction value of a child node of the current node is determined based on attribute information of neighbouring nodes of the current node. In this way, when the attribute of each node is predicted, the judgment condition of whether to perform the attribute prediction for each node is optimized, so that the attributes coding efficiency of the point cloud can be improved while ensuring the complexity of the coding of the attribute of the point cloud. In addition, it is not necessary to store the number of neighbouring nodes of each node, and the memory occupied by the point cloud attribute encoding and decoding can be further reduced, thereby improving the encoding and decoding performance of the point cloud.

The above descriptions are merely specific implementations of the disclosure, but the scope of protection of the present application is not limited thereto. Any variation or replacement readily figured out by a person skilled in the art within the technical scope disclosed in the disclosure shall fall within the scope of protection of the disclosure. Therefore, the scope of protection of the disclosure shall be subject to the scope of protection of the claims.

### INDUSTRIAL PRACTICALITY

In the embodiments of the present disclosure, whether at the encoding end or the decoding end, a number of neighbouring nodes of a parent node of a current node is determined. When the number of the neighbouring nodes of the parent node of the current node is greater than or equal to a preset threshold, it is determined that attribute prediction is allowed for the current node, and an attribute prediction value of a child node of the current node is determined based on attribute information of neighbouring nodes of the current node. In this way, when the attribute of each node is predicted, the starting condition of whether the prediction coding is performed for each node is optimized, so that the efficiency of the coding of the attributes of the point cloud can be improved while ensuring the complexity of the coding of the attributes of the point cloud. In addition, it is not necessary to store the number of the neighbouring nodes of each node, and the memory occupied by the point cloud attribute encoding and decoding can be further reduced, thereby improving the encoding and decoding performance of the point cloud.

1. A decoding method, applied to a decoder, the method comprising:
determining a number of neighbouring nodes of a parent node of a current node;
when the number of the neighbouring nodes of the parent node of the current node is greater than or equal to a preset threshold, determining that attribute prediction is allowed for the current node; and
determining an attribute prediction value of a child node of the current node based on attribute information of neighbouring nodes of the current node.

2. The method of claim 1, further comprising:
performing upsampling based on geometric information of the current node to determine the child node of the current node.

3. The method of claim 1, further comprising:
determining the neighbouring nodes of the current node based on a spatial position of the current node,
wherein the neighbouring nodes of the current node at least comprise neighbouring nodes coplanar with the current node and neighbouring nodes collinear with the current node.

4. The method of claim 1, further comprising:
determining the parent node of the current node; and
determining the neighbouring nodes of the parent node of the current node based on a spatial position of the parent node of the current node,
wherein the neighbouring nodes of the parent node of the current node at least comprise neighbouring nodes coplanar with the parent node of the current node and neighbouring nodes collinear with the parent node of the current node.

5. The method of claim 4, wherein determining the number of the neighbouring nodes of the parent node of the current node comprises:
performing statistics on the number of the neighbouring nodes of the parent node of the current node to determine the number of the neighbouring nodes of the parent node of the current node.

6. The method of claim 1, wherein determining the attribute prediction value of the child node of the current node based on the attribute information of the neighbouring nodes of the current node comprises:
determining geometric distances between the neighbouring nodes of the current node and the child node of the current node; and
performing linear fitting according to the attribute information of the neighbouring nodes of the current node and the geometric distances between the neighbouring nodes of the current node and the child node of the current node, to determine the attribute prediction value of the child node of the current node.

7. The method of claim 1, further comprising:
determining an reconstructed attribute value of the child node of the current node based on the attribute prediction value of the child node of the current node.

8. The method of claim 7, wherein determining the reconstructed attribute value of the child node of the current node based on the attribute prediction value of the child node of the current node comprises:
performing forward transform on the attribute prediction value of the child node of the current node according to a region adaptive hierarchical transform (RAHT) mode to determine a value of a first coefficient and a prediction value of a second coefficient of the child node of the current node;
determining a value of the second coefficient of the child node of the current node according to the prediction value of the second coefficient of the child node of the current node; and
performing inverse transform on the value of the first coefficient and the value of the second coefficient of the child node of the current node according to the RAHT mode to determine the reconstructed attribute value of the child node of the current node.

9. The method of claim 8, wherein determining the value of the second coefficient of the child node of the current node according to the prediction value of the second coefficient of the child node of the current node comprises:
decoding a bitstream to determine a decoded residual value of the second coefficient of the child node of the current node;
performing inverse quantization on the decoded residual value of the second coefficient to obtain an inverse quantization residual value of the second coefficient of the child node of the current node; and
determining the value of the second coefficient of the child node of the current node according to the prediction value of the second coefficient and the inverse quantization residual value of the second coefficient.

10. The method of claim 9, wherein determining the value of the second coefficient of the child node of the current node according to the prediction value of the second coefficient and the inverse quantization residual value of the second coefficient comprises:
performing an addition operation on the prediction value of the second coefficient and the inverse quantization residual value of the second coefficient to obtain the value of the second coefficient of the child node of the current node.

11. The method of claim 1, further comprising:
when the number of the neighbouring nodes of the parent node of the current node is less than the preset threshold, determining that the attribute prediction is not performed on the current node, taking a next node as the current node, and continuing performing the operation of determining the number of the neighbouring nodes of the parent node of the current node.

12. The method of claim 1, further comprising:
decoding a bitstream to determine an attribute prediction mode of the current node; and
when the attribute prediction mode indicates performing attribute decoding on the current node by using a region adaptive hierarchical transform (RAHT) mode, performing the operation of determining the number of the neighbouring nodes of the parent node of the current node.

13. An encoding method, applied to an encoder, the method comprising:
determining a number of neighbouring nodes of a parent node of a current node;
when the number of the neighbouring nodes of the parent node of the current node is greater than or equal to a preset threshold, determining that attribute prediction is allowed for the current node; and
determining an attribute prediction value of a child node of the current node based on attribute information of neighbouring nodes of the current node.

14. The method of claim 13, further comprising:
performing upsampling based on geometric information of the current node to determine the child node of the current node.

15. The method of claim 13, further comprising:
determining the neighbouring nodes of the current node based on a spatial position of the current node,
wherein the neighbouring nodes of the current node at least comprise neighbouring nodes coplanar with the current node and neighbouring nodes collinear with the current node.

16. The method of claim 13, further comprising:
determining the parent node of the current node; and
determining the neighbouring nodes of the parent node of the current node based on a spatial position of the parent node of the current node,
wherein the neighbouring nodes of the parent node of the current node at least comprise neighbouring nodes coplanar with the parent node of the current node and neighbouring nodes collinear with the parent node of the current node.

17. The method of claim 16, wherein determining the number of the neighbouring nodes of the parent node of the current node comprises:
performing statistics on the number of the neighbouring nodes of the parent node of the current node to determine the number of the neighbouring nodes of the parent node of the current node.

18. The method of claim 13, wherein determining the attribute prediction value of the child node of the current node based on the attribute information of the neighbouring nodes of the current node comprises:
determining geometric distances between the neighbouring nodes of the current node and the child node of the current node; and
performing linear fitting according to the attribute information of the neighbouring nodes of the current node and the geometric distances between the neighbouring nodes of the current node and the child node of the current node, to determine the attribute prediction value of the child node of the current node.

19. The method of claim 13, further comprising:
determining a prediction residual value of a second coefficient of the child node of the current node according to the attribute prediction value of the child node of the current node;
performing quantization on the prediction residual value of the second coefficient to determine a quantization residual value of the second coefficient of the child node of the current node; and
encoding the quantization residual value of the second coefficient of the child node of the current node and signalling obtained encoded bits into a bitstream.

20. A non-transitory computer-readable storage medium, having a computer program and a bitstream stored thereon, wherein the computer program, when executed by a processor, enables the processor to perform the following operations to generate the bitstream:
determining a number of neighbouring nodes of a parent node of a current node;
when the number of the neighbouring nodes of the parent node of the current node is greater than or equal to a preset threshold, determining that attribute prediction is allowed for the current node; and
determining an attribute prediction value of a child node of the current node based on attribute information of neighbouring nodes of the current node.
